(19) United States
(12) Patent Application Publication
(10) Pub. No.: US 2026/0348908 A1
(43) Pub. Date: Nov. 5, 2026

(54) ELECTROPHORESIS DATA PROCESSING DEVICE AND ELECTROPHORESIS DATA PROCESSING METHOD

(71) Applicant: HITACHI HIGH-TECH CORPORATION, Tokyo (JP)

(72) Inventors: Yoshihiko HAGIWARA, Tokyo (JP); Motohiro YAMAZAKI, Tokyo (JP); Isao HARAURA, Tokyo (JP); Hirokazu KATO, Tokyo (JP)

(21) Appl. No.: 19/133,404

(22) PCT Filed: Dec. 13, 2022
(86) PCT No.: PCT/JP2022/045941

§ 371 Date: May 28, 2025

(51) Int. Cl. G01N 27/447

(52) U.S. Cl. CPC G01N 27/44721

(57) ABSTRACT

To improve the accuracy of determining whether or not saturation has occurred in a measurement unit of an electrophoretic device, there are provided a spectrum generation unit that generates a spectrum of a signal acquired from a measurement unit of an electrophoresis device in which binning is performed to virtually integrate light receiving elements that receive light dispersed from fluorescence emitted from a capillary included in the electrophoresis device, and a saturation determination value setting unit that determines, based on a shape of the generated spectrum, whether saturation has occurred in the measurement unit.

### TECHNICAL FIELD

The present invention relates to a technique for an electrophoresis data processing device and an electrophoresis data processing method.

### BACKGROUND ART

For analysis of biological samples, a multi-capillary electrophoresis device (hereinafter referred to as an electrophoresis device) is widely used. In the electrophoresis device, a plurality of capillaries are filled with an electrophoresis separation medium, such as an electrolyte solution or an electrolyte solution containing a polymer gel or a polymer. Then, electrophoretic analysis is performed in parallel. Objects to be analyzed in electrophoresis are broad, ranging from low molecules to polymers such as proteins and nucleic acids.

Particularly, a nucleic acid is detected by the electrophoresis device in the following procedure. First, a sample containing a nucleic acid with a fluorescent label is irradiated with excitation light. The base sequence and the length of the nucleic acid are analyzed based on a fluorescent signal emitted by the fluorescent label. The electrophoresis device detects the fluorescent signal with an image sensor such as a charge coupled device (CCD) image sensor or a complementary metal oxide semiconductor (CMOS) image sensor. Then, the electrophoresis device generates a signal intensity for each wavelength based on the detected fluorescent signal and analyzes the base sequence and the length of the nucleic acid.

In the electrophoresis device, the higher the concentration of a sample to be electrophoresed, the higher the generated signal intensity linearly. However, in a case where the concentration of the sample is higher than or equal to a certain value, the amount of electrical charges generated in the image sensor due to the fluorescent signal emitted by the fluorescent label exceeds a saturation electrical charge amount of the image sensor. In this case, the concentration of the sample and the signal intensity generated do not have a linear relationship. This is referred to as saturation or out of detection limit.

Meanwhile, nucleic acids may be used in the diagnosis of disease by calculating the ratio of a wild-type nucleic acid to a mutant nucleic acid.

When a sample in which saturation has occurred is determined to be a sample in which saturation has not occurred, and a signal intensity obtained from the sample is used, the mutation rate cannot be correctly detected. That is, it is not preferable to determine a sample in which saturation has occurred as being a sample in which saturation has not occurred. Therefore, it is necessary to determine whether or not saturation has occurred in a signal, and to mark a signal in which saturation has occurred in order to alert a user.

In an electrophoresis device, saturation is defined based on saturation electrical charge amounts of an image sensor and an analog-to-digital converter. For example, Patent Literature 1 describes a multi-capillary electrophoresis device that “includes a multi-capillary array electrophoresis unit in which a plurality of capillary columns are arrayed, the respective capillary columns are filled with a plurality of samples, and electrophoresis is conducted simultaneously in all of the capillary columns, an optical measurement unit that irradiates capillaries with light in the multi-capillary array electrophoresis unit, scans irradiated positions in a direction orthogonal to an electrophoresis direction, detects the intensity of light from the samples in the irradiated portions, and measures a scanning waveform, and a data processing unit that creates time-series data regarding the capillaries using, as data, measured light intensity values at predetermined positions of the capillaries from the scanning waveform obtained by the optical measurement unit, and includes a correction data storage unit that stores, for peaks of the scanning waveform that are saturated beyond a detection range of a detector of the optical measurement unit or an input range of an A/D converter when the data is input to the data processing unit, correction data indicating a relationship between the number of data points in a saturated portion and light intensity data in a case where the peaks are not saturated, and a saturation data correction unit that corrects the measured light intensity value based on the correction data stored in the correction data storage unit for a peak that is saturated among the peaks of the scanning waveform, and that creates the time-series data based on the measured light intensity value corrected by the saturation data correction unit for the saturated scanning waveform peak” (see claim 1).

In addition, the determination as to whether saturation has occurred is performed based on a signal intensity. For example, Patent Literature 2 describes that “electrons from a CCD are combined together before being read into digital numbers from 0 to 65535. However, if too many electrons are present and converted into a signal in which the number of combinations thereof exceeds the limit of 65535, an obtained measurement signal is not accurate. Such a signal is referred to as “saturation” or “out-of-measurement limit”. (see Description of Embodiments). In addition, Patent Literature 2 describes, as a method of adding a saturation mark, “identifying a bin of the image for generation of a signal with a larger number of electrons than the maximum camera signal and setting an out-of-measurement limit mark on the identified bin” (see claim 1). Patent Literature 2 discloses that when the signal intensity exceeds “65535” (unit: analog to digital unit (ADU) ), the saturation mark is added to the bin.

### CITATION LIST

### Patent Literature

Patent Literature 1: Japanese Patent No. 4,175,735

Patent Literature 2: U.S. Patent Application Publication No. 2020/0074624

### SUMMARY OF INVENTION

### Technical Problem

Patent Literature 1 describes that “when the detection range of the detector of the optical measurement unit or the input range of the A/D converter when the data is input to the data processing unit is exceeded”, saturation occurs, but does not describe how to detect the saturation.

In addition, in Patent Literature 2, when the signal intensity exceeds “65535” (ADU), it is determined that saturation has occurred, and the mark is added to a bin where the saturation has occurred.

Binning is known, in which a plurality of light receiving elements constituting an image sensor are integrated in a pseudo manner and treated as if the light receiving elements were a single light receiving element. When the number of light receiving surfaces to be binned is large, saturation is determined based on the saturation electrical charge amount of the analog-to-digital converter, instead of the saturation electrical charge amount of the image sensor. On the other hand, when the number of light receiving surfaces to be binned is small, saturation is determined based on the saturation electrical charge amount of the image sensor, instead of the saturation electrical charge amount of the analog-to-digital converter.

In addition, there are differences between the devices in terms of the saturation electrical charge amount of the image sensor and the saturation electrical charge amount of the analog-to-digital converter. Therefore, the fluorescent signal intensity at the time of saturation varies depending on the device.

Therefore, in a method in which a fixed threshold is provided and it is determined that saturation has occurred when a signal intensity is greater than or equal to the threshold, it may not be possible to detect saturation. If a signal in which saturation has occurred is determined to be a signal in which saturation has not occurred, and the intensity of the signal is used, misdiagnosis may be performed.

The present invention has been made in view of the above-described circumstances, and an object of the present invention is to improve the accuracy of determining whether or not saturation has occurred in a measurement unit of an electrophoretic device.

### Solution to Problem

To solve the above-described problems, according to the present invention, an electrophoresis device includes a spectrum generation unit that generates a spectrum of a signal acquired from a measurement unit of the electrophoresis device in which binning is performed to virtually integrate light receiving elements that receive light dispersed from fluorescence emitted from a capillary included in the electrophoresis device, and a saturation determination processing unit that determines, based on a shape of the generated spectrum, whether or not saturation has occurred in the measurement unit.

Other solutions will be described in embodiments as appropriate.

### Advantageous Effects of Invention

According to the present invention, it is possible to improve the accuracy of determining whether saturation has occurred in a measurement unit of an electrophoresis device.

### BRIEF DESCRIPTION OF DRAWINGS

FIG. 1 is a diagram illustrating an outline of an example of a configuration of an electrophoresis device according to a first example of a first embodiment.

FIG. 2 is a diagram illustrating an outline of a configuration of a fluorescence detection device according to the first example of the first embodiment.

FIG. 3 is a diagram illustrating an outline of a configuration of a CCD image sensor according to the first example of the first embodiment.

FIG. 4 is a diagram illustrating a configuration of a processing unit according to the first example of the first embodiment.

FIG. 5 is a (first) diagram for explaining an operation of converting a dispersed fluorescent signal into a digital signal.

FIG. 6 is a (second) diagram for explaining an operation of converting a dispersed fluorescent signal into a digital signal.

FIG. 7 is a (third) diagram for explaining an operation of converting a dispersed fluorescent signal into a digital signal.

FIG. 8 is a diagram illustrating timings at which a control unit applies pulses.

FIG. 9 is a diagram illustrating an example of a configuration of a generalized bin.

FIG. 10 is a diagram illustrating an outline of a measurement unit and a processing unit according to the first example of the first embodiment.

FIG. 11 is a flowchart of a procedure of a process of setting a saturation determination value according to the first example of the first embodiment.

FIG. 12 is a flowchart of a procedure of a saturation determination process by a saturation determination unit according to the first example of the first embodiment.

FIG. 13 is a diagram illustrating an example of a spectrum in which saturation has not occurred.

FIG. 14 is a diagram illustrating an example of a spectrum in which saturation has occurred in a summing gate.

FIG. 15 is a diagram illustrating an example of a spectrum in which saturation has occurred in an electrical charge storage element.

FIG. 16 is a diagram illustrating an example of an electrophoretic image.

FIG. 17 is a diagram illustrating an example of a spectrum according to the first example of the first embodiment.

FIG. 18A is a (first) schematic diagram illustrating a case where saturation has occurred in a case where nine light receiving elements constitute a bin.

FIG. 18B is a (second) schematic diagram illustrating the case where the saturation has occurred in the case where the nine light receiving elements constitute the bin.

FIG. 18C is a (third) schematic diagram illustrating the case where the saturation has occurred in the case where the nine light receiving elements constitute the bin.

FIG. 19A is a (first) schematic diagram illustrating a case where saturation has occurred in a case where three light receiving elements constitute a bin.

FIG. 19B is a (second) schematic diagram illustrating the case where the saturation has occurred in the case where the three light receiving elements constitute the bin.

FIG. 19C is a (third) schematic diagram illustrating the case where the saturation has occurred in the case where the three light receiving elements constitute the bin.

FIG. 20 is a diagram illustrating an outline of a configuration of an electrophoresis device according to a second example of the first embodiment.

FIG. 21 is a diagram illustrating an example of a detailed configuration of a processing unit according to the second example of the first embodiment.

FIG. 22 is a flowchart illustrating a procedure of a Saturation determination process by a saturation determination unit according to the second example of the first embodiment.

FIG. 23 is a diagram illustrating a configuration of a processing unit according to a third example of the first embodiment.

FIG. 24 is a flowchart illustrating a procedure of a process of setting a saturation determination value by a saturation determination value setting unit according to the third example of the first embodiment.

FIG. 25 is a flowchart illustrating a procedure of a process of setting a saturation determination value according to a first example of a second embodiment.

FIG. 26 is a (first) diagram illustrating a spectrum and an absolute value of a second derivative for the spectrum.

FIG. 27 is a (second) diagram illustrating a spectrum and an absolute value of a second derivative for the spectrum.

FIG. 28 is a flowchart illustrating a procedure of a saturation determination process according to a second example of the second embodiment.

FIG. 29 is a flowchart illustrating a procedure of a process of setting a saturation determination value according to a third example of the second embodiment.

FIG. 30 is a diagram illustrating an outline of a configuration of an electrophoresis device according to a first example of a third embodiment.

FIG. 31 is a diagram illustrating details of a configuration of a processing unit according to the first example of the third embodiment.

FIG. 32 is a flowchart illustrating a procedure of a process of setting a saturation determination value according to the first example of the third embodiment.

FIG. 33 is a diagram illustrating details of a configuration of a processing unit according to a second example of the third embodiment.

FIG. 34 is a flowchart illustrating a procedure of saturation determination by a saturation determination unit according to the second example of the third embodiment.

FIG. 35 is a diagram illustrating a configuration of a processing unit according to a third example of the third embodiment.

FIG. 36 is a flowchart illustrating a procedure of a process of setting a saturation determination value according to the third example of the third embodiment.

FIG. 37 is a diagram illustrating a hardware configuration of each processing unit.

### DESCRIPTION OF EMBODIMENTS

Hereinafter, embodiments of the present invention will be described with reference to the drawings. In all of the drawings for explaining the embodiments, in principle, the same components are denoted by the same reference signs, and repeated descriptions will be omitted.

### First Embodiment

### First Example of First Embodiment

### [System Configuration]

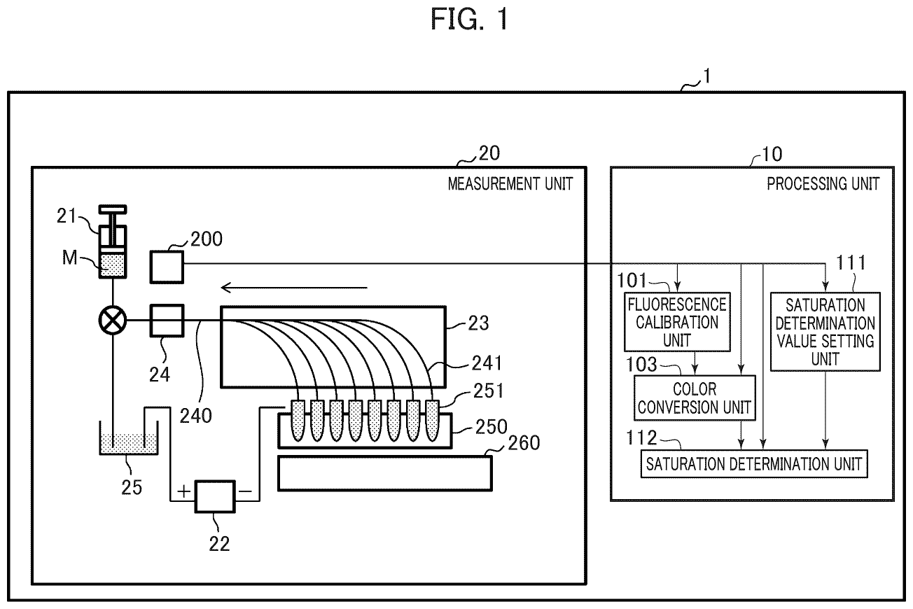

FIG. 1 is a diagram illustrating an outline of an example of a configuration of an electrophoresis device 1 according to a first example of a first embodiment.

As illustrated in FIG. 1, the electrophoresis device 1 includes a processing unit 10 that is an electrophoresis data processing device, and a measurement unit 20.

### (Measurement Unit 20)

The measurement unit 20 includes a pump unit 21, a high voltage power source 22, a thermostatic bath 23, a fluorescence detection device 200, and a capillary array 240. The measurement unit 20 further includes a sample tray 250 and a transport unit 260.

The sample tray 250 accommodates a plurality of sample containers 251. Each of the sample containers 251 is a container for storing a sample in which a fluorescent label has been added to a deoxyribonucleic acid (DNA) to be measured. Different samples are stored in the respective sample containers 251.

The transport unit 260 transports the sample tray 250 such that the sample containers 251 are located at positions of tips of capillaries 241.

The capillary array 240 includes the plurality of capillaries 241. Each of the capillary 241 is hollow. The capillaries 241 are inserted into the respective sample containers 251.

The thermostatic bath 23 keeps the inside of the capillary array 240 at a constant temperature.

The pump unit 21 injects an electrophoretic medium M (e. g., a polymer) into each of the capillaries 241.

Therefore, the inside of each of the capillaries 241 is filled with the electrophoresis medium M.

The high voltage power source 22 applies a high pressure to both ends of each of the capillaries 241 filled with the electrophoresis medium M.

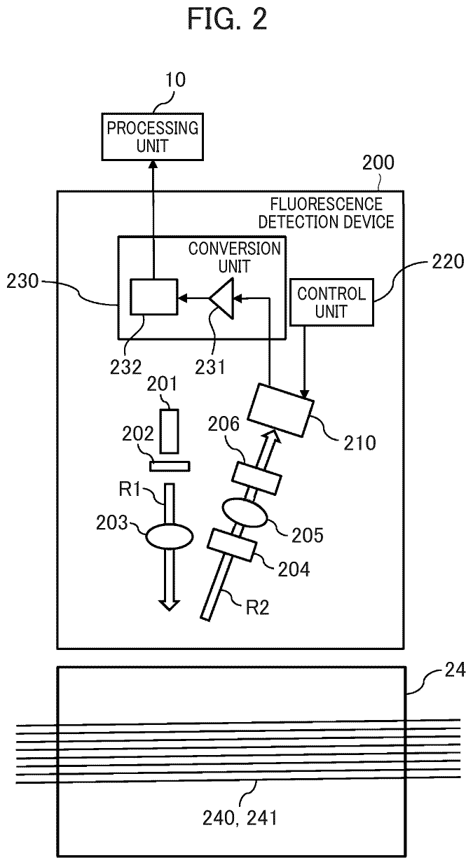

A fluorescence detection position 24 is located on a path in which the samples are electrophoresed. At the fluorescence detection position 24, the samples are irradiated with excitation light R1 (see FIG. 2).

The samples are electrophoresed in the capillaries 241 by the high voltage power source 22 and move in the capillaries 241. A direction in which the samples move is indicated by an arrow. The samples that have moved in the capillaries 241 are irradiated with excitation light R1 (see FIG. 2) at the fluorescence detection position 24 and emit fluorescence. Thereafter, the samples are discharged into a discharge container 25. In addition, the fluorescence detection device 200 detects a fluorescent signal R2 (see FIG. 2) based on the fluorescence emitted from the samples at the fluorescence detection position 24. A detailed configuration of the fluorescence detection device 200 will be described later. Since the measurement unit 20 has the above-described configuration, the samples that are electrophoresed in the plurality of capillaries 241 can be concurrently measured.

In the present example of the first embodiment, although DNA fragments to which fluorescent labels have been added are assumed as the samples that pass through the insides of the capillaries 241, a sample other than a DNA fragment may also be used.

### (Processing Unit 10)

The processing unit 10 includes a fluorescence calibration unit 101, a color conversion unit 103, a saturation determination value setting unit 112, and a saturation determination unit 113. Configurations of the units of the processing unit 10 and processes to be executed by the units will be described in an operation section.

(fluorescence Detection Device 200)

FIG. 2 is a diagram illustrating an outline of a configuration of the fluorescence detection device 200 according to the first example of the first embodiment.

As illustrated in FIG. 2, the fluorescence detection device 200 includes an excitation light source 201, a shutter 202, and an excitation light lens 203. The fluorescence detection device 200 further includes an optical filter 204, a fluorescent lens 205, a diffraction grating 206, and a CCD image sensor 210. The fluorescence detection device 200 further includes a control unit 220 and a conversion unit 230.

The excitation light source 201 continuously emits excitation light R1. The excitation light source 201 is provided to emit the excitation light R1 to all of the capillaries 241 included in the capillary array 240 passing through the fluorescence detection position 24.

The shutter 202 is repeatedly opened and closed at predetermined time intervals. That is, when the shutter 202 is opened, the capillaries 241 are irradiated with the excitation light R1 emitted from the excitation light source 201. When the shutter 202 is closed, the irradiation of the capillaries 241 with the excitation light R1 is blocked.

The excitation light lens 203 collects the excitation light R1 that has passed through the shutter 202. The excitation light R1 collected by the excitation light lens 203 is radiated toward the fluorescence detection position 24.

As described above, as the samples that pass through the insides of the capillaries 241, the DNA fragments to which the fluorescent labels have been added are used as described above. Each of the fluorescent labels added to the DNA fragments being electrophoresed in the capillaries 241 is excited by the irradiation with the excitation light R1 and emits a fluorescent signal R2.

The optical filter 204 (for example, a color filter) cuts light other than the fluorescent signal R2 emitted from each of the fluorescent labels. As the optical filter 204, for example, a color filter is used.

The fluorescent lens 205 collects the fluorescent signal R2 that has passed through the optical filter 204.

The diffraction grating 206 disperses the fluorescent signal R2 collected by the fluorescent lens 205.

The CCD image sensor 210 receives the fluorescent signal R2 dispersed by the diffraction grating 206 and output an electrical charge whose intensity corresponds to the signal intensity of the fluorescent signal R2.

The control unit 220 instructs the CCD image sensor 210 to output the electrical charge based on the fluorescent signal R2.

The conversion unit 230 includes an electrical charge conversion unit 231 and a digital conversion unit 232 that is an analog-to-digital converter (ADC).

The electrical charge conversion unit 231 converts the electrical charge output from the CCD image sensor 210 into a voltage and outputs the converted voltage as an analog signal.

The digital conversion unit 232 converts the analog signal output from the electrical charge conversion unit 231 into a digital signal. Then, the digital conversion unit 232 outputs the converted digital signal to the processing unit 10.

Next, measurement of a sample will be described with reference to FIGS. 1 and 2.

First, the samples are stored in the sample containers 251. Then, the high voltage power source 22 applies a high voltage to both ends of each of the capillaries 241, and thus the samples move from the sample containers 251 into the capillaries 241. Therefore, the samples move in the capillaries 241 toward the discharge container 25 through the fluorescence detection position 24 (electrophoresis). When the samples are electrophoresed, the speeds at which the samples move vary depending on the base lengths of the DNA fragments as the samples, and thus the DNA fragments reach the fluorescence detection position 24 in order from a DNA fragment with the shortest base length. The samples that have reached the fluorescence detection position 24 are irradiated with the excitation light R1 that has been emitted from the excitation light source 201, has passed through the shutter 202, and has been collected by the excitation light lens 203. Each of the fluorescent labels added to the DNA fragments is excited by the irradiation with the excitation light R1 and emits the fluorescent signal R2. The fluorescent signal R2 passes through the optical filter 204, is collected by the fluorescent lens 205, and is dispersed by the diffraction grating 206 for each wavelength.

### (CCD Image Sensor 210)

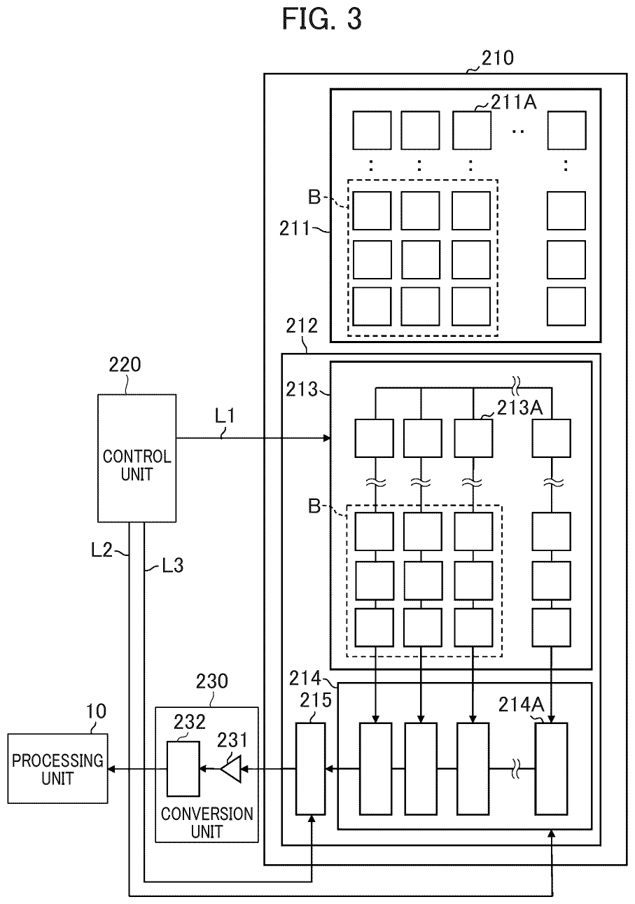

FIG. 3 is a diagram illustrating an outline of a configuration of the CCD image sensor 210 according to the first example of the first embodiment. Refer to FIG. 2 as appropriate.

As illustrated in FIG. 3, the CCD image sensor 210 includes a light receiving unit 211 and an accumulation unit 212.

The light receiving unit 211 includes a plurality of light receiving elements 211A arranged in a lattice pattern. Each of the light receiving elements 211A is a surface for receiving the fluorescent signal R2 dispersed by the diffraction grating 206 for each wavelength. That is, the light receiving elements 211A receive light obtained by dispersing the fluorescence emitted from the capillaries 241 included in the electrophoresis device 1. Upon receiving the fluorescent signal R2, the light receiving elements 211A output a signal electrical charge corresponding to the intensity of the fluorescent signal R2.

The accumulation unit 212 includes an electrical charge storage unit 213, a horizontal register unit 214, and a summing gate 215.

The electrical charge storage unit 213 includes electrical charge storage elements 213A associated with the light receiving elements 211A on a one-to-one basis. Each of the electrical charge storage elements 213A stores an electrical charge transferred from a corresponding one of the light receiving elements 211A. In addition, the electrical charge storage unit 213 is connected to the control unit 220 via a pulse line L1. Each of the electrical charge storage elements 213A included in the electrical charge storage unit 213 outputs the electrical charge in accordance with an instruction from the control unit 220 through the pulse line L1. The output of the electrical charges by the electrical charge storage elements 213A will be described later in detail.

The horizontal register unit 214 includes a plurality of horizontal registers 214A. The horizontal registers 214A accumulate the electrical charges stored in the electrical charge storage elements 213A in a vertical direction. In the present example of the first embodiment, a direction from the electrical charge storage unit 213 to the horizontal registers 214A is referred to as the vertical direction, and a direction from the horizontal register unit 214 to the summing gate 215 is referred to as a horizontal direction. The horizontal register unit 214 is connected to the control unit 220 via a pulse line L2. Each of the horizontal registers 214A constituting the horizontal register unit 214 outputs the electrical charge in accordance with an instruction from the control unit 220 through the pulse line L2. The output of electrical charges by the horizontal registers 214A will be described later in detail.

The summing gate 215 accumulates the electrical charges accumulated by the horizontal register unit 214 in the horizontal direction. The summing gate 215 is connected to the control unit 220 via a pulse line L3. The summing gate 215 outputs the accumulated electrical charges in accordance with an instruction from the control unit 220 through the pulse line L3.

It should be noted that the CCD image sensor 210 may be of any of a frame transfer type, a full frame transfer type, an interline transfer type, and a frame interline transfer type. In a case where the frame transfer type, the interline transfer type, or the frame interline transfer type is used, the shutter 202 is not required (see FIG. 2). In addition, in a case where the full frame transfer type is used, it is possible to detect a minute signal by increasing the number of light receiving elements 211A and the area of each of the light receiving elements 211A.

A complementary metal oxide semiconductor (CMOS) image sensor may be used to detect the fluorescent signal R2 (see FIG. 2) instead of the CCD image sensor 210. In a case where the CMOS image sensor is used, a digital signal can be directly acquired from each of the light receiving elements 211A.

### [Processing Unit 10]

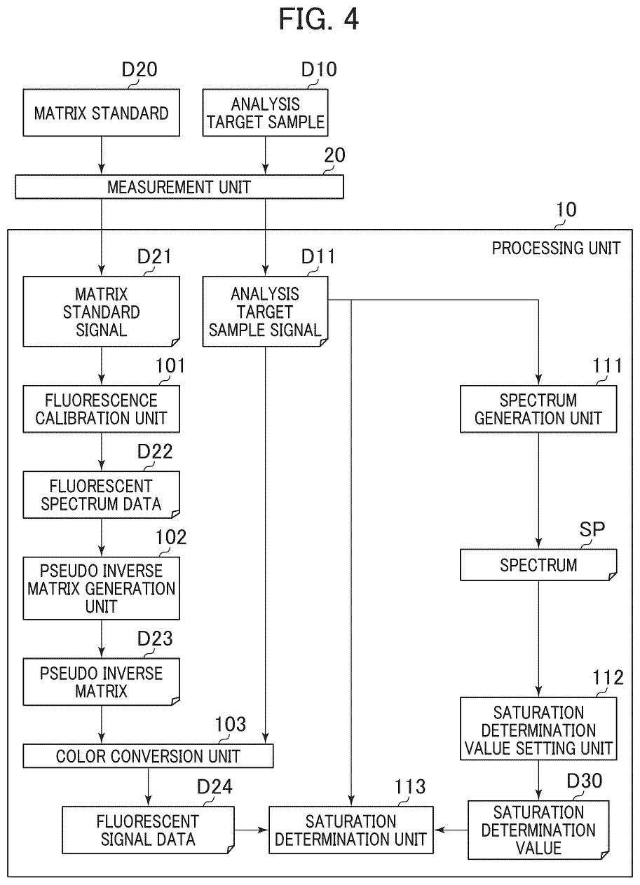

FIG. 4 is a diagram illustrating a configuration of the processing unit 10 according to the first example of the first embodiment. Refer to FIG. 1 as appropriate.

The processing unit 10 includes the fluorescence calibration unit 101, a pseudo inverse matrix generation unit 102, the color conversion unit 103, a spectrum generation unit 111, the saturation determination value setting unit 112, and the saturation determination unit 113. In the electrophoresis device 1, in order to obtain a signal intensity from a sample (hereinafter referred to as an analysis target sample D10) to be analyzed, a matrix standard D20 is used in addition to the analysis target sample D10. The matrix standard D20 is a sample for fluorescence calibration. In the present example of the first embodiment, the analysis target sample D10 is a DNA fragment to which a fluorescent label has been added.

In the processing unit 10, processing to be performed by the fluorescence calibration unit 101, the pseudo inverse matrix generation unit 102, the color conversion unit 103, the spectrum generation unit 111, the saturation determination value setting unit 112, and the saturation determination unit 113 will be described later. An analysis target sample signal D11, a matrix standard signal D21, fluorescent spectrum data D22, a pseudo inverse matrix D23, a spectrum SP, and a saturation determination value D30 will be described later as well.

### [Example in Which Saturation Has Occurred in Summing Gate 215]

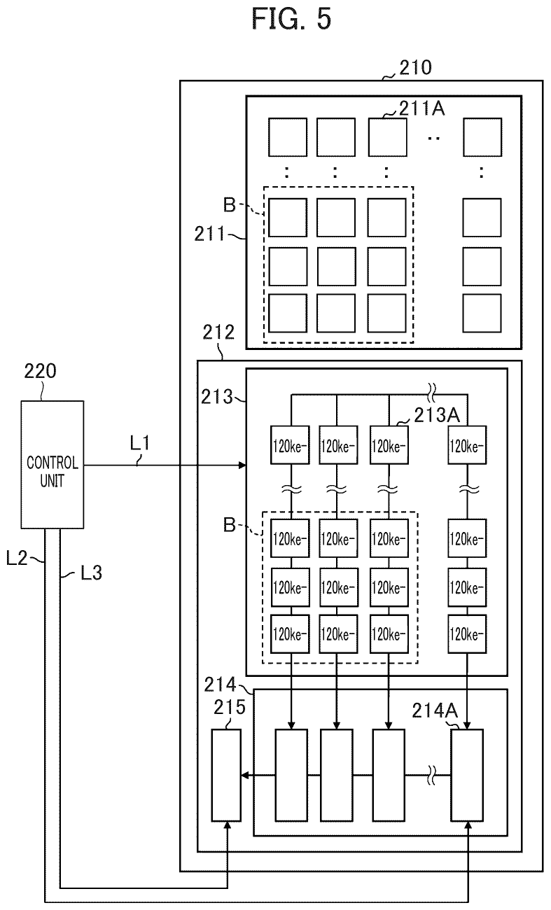

FIGS. 5 to 7 are diagrams for explaining an operation of converting the dispersed fluorescent signal R2 (see FIG. 2) into a digital signal and illustrate an example in which saturation has occurred in the summing gate 215. Refer to FIG. 2 as appropriate. In FIGS. 5 to 7 (and FIG. 3), broken lines indicating the receiving elements 211A and the electrical charge storage elements 213A indicate bins B. The bins B will be described later.

First, as illustrated in FIG. 2, the fluorescent signal R2 dispersed by the diffraction grating 206 (see FIG. 2) for each wavelength is received by the light receiving elements 211A of the measurement unit 20. As illustrated in FIG. 5, electrical charges are stored in the electrical charge storage elements 213A corresponding to the light receiving elements 211A. In the present example of the first embodiment, it is assumed that electrical charges of “120 ke-” are generated in each of the light receiving elements 211A. As described above, since the electrical charge storage elements 213A correspond to the light receiving elements 211A on a one-to-one basis, electrical charges of “120 ke-” are stored in each of the electrical charge storage elements 213A. In the present example of the first embodiment, it is assumed that the saturation electrical charge amount of each of the electrical charge storage elements 213A is “320 ke-”, the saturation electrical charge amount of each of the horizontal registers 214A is “1000 ke-”, and the saturation electrical charge amount of the summing gate 215 is “1000 ke-”. In the present example of the first embodiment, it is assumed that the digital conversion unit 232 converts an analog signal value when the summing gate 215 is saturated into a digital signal value “65535” (ADU). These operations are performed in synchronization with the timing at which the shutter 202 is opened. A period from a state where the shutter 202 is closed to a state where the shutter 202 is opened to a state where the shutter 202 is closed again is referred to as a frame. The shutter 202 is closed for a period for which electrical charges are transferred from the light receiving elements 211A to the processing unit 10.

Next, the control unit 220 applies a pulse to the pulse line L1 to transfer the electrical charges stored in the electrical charge storage elements 213A in the vertical direction. When the pulse is applied to the pulse line L1, the electrical charges stored in the electrical charge storage elements 213A are sequentially transferred in the vertical direction for each of the light receiving elements 211A.

In addition, the electrical charges stored in the electrical charge storage elements 213A located at the end in the vertical direction are transferred to the horizontal registers 214A.

Subsequently, the control unit 220 applies, to the pulse line L1, the pulse to transfer the electrical charges stored in the electrical charge storage elements 213A in the vertical direction again. When the pulse is applied to the pulse line L1, the electrical charges stored in the electrical charge storage elements 213A are sequentially transferred in the vertical direction.

In addition, the electrical charges stored in the electrical charge storage elements 213A located at the end in the vertical direction are transferred to the horizontal registers 214A. Therefore, the previously transferred electrical charges and the currently transferred electrical charges are stored in the horizontal registers 214A.

Then, the control unit 220 further applies, to the pulse line L1, the pulse to transfer the electrical charges stored in the electrical charge storage elements 213A in the vertical direction. When the pulse is applied to the pulse line L1, the electrical charges stored in the electrical charge storage elements 213A are sequentially transferred in the vertical direction for each of the electrical charge storage elements 213A.

In addition, the electrical charges stored in the electrical charge storage elements 213A located at the end in the vertical direction are transferred to the horizontal registers 214A. Therefore, the electrical charges transferred two times before the current transfer, the previously transferred electrical charges, and the currently transferred electrical charges are stored in the horizontal registers 214A. That is, every time the pulse is applied to the pulse line L1, electrical charges stored in the electrical charge storage elements 213A are sequentially transferred to the horizontal registers 214A.

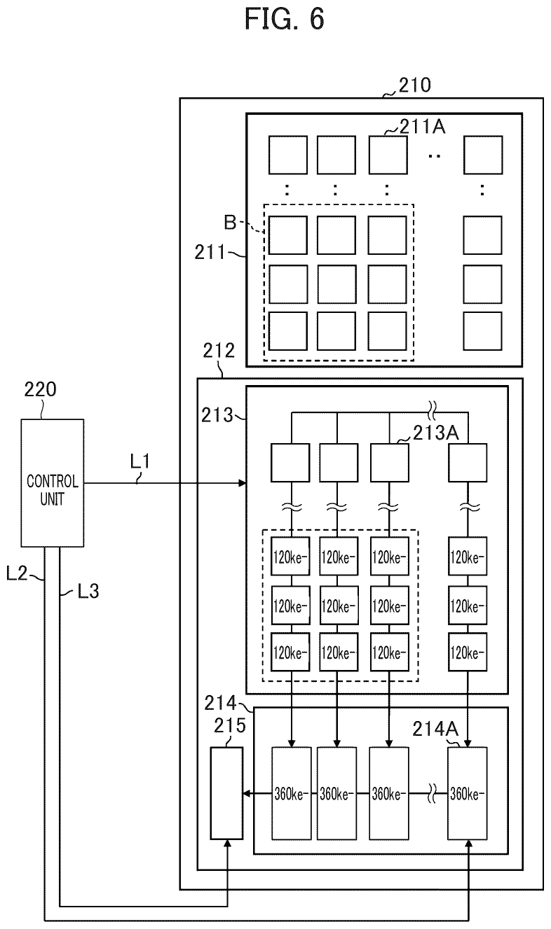

In the present example of the first embodiment, the pulse is applied to the pulse line L1 three times in total, and thus the electrical charges are stored in the horizontal register 214A as illustrated in FIG. 6. That is, the electrical charges of 120 ke-×3=“360 ke-” are stored in each of the horizontal registers 214A.

Next, the control unit 220 applies, to the pulse line L2, a pulse to transfer the electrical charges stored in the horizontal registers 214A in the horizontal direction. When the pulse is applied to the pulse line L2, the electrical charges stored in the horizontal registers 214A are sequentially transferred in the horizontal direction.

The electrical charges stored in the horizontal register 214A located at the end in the horizontal direction are transferred to the summing gate 215.

Then, the control unit 220 applies, to the pulse line L2, the pulse to transfer the electrical charges stored in the horizontal registers 214A in the horizontal direction again. When the pulse is applied to the pulse line L2, the electrical charges stored in the horizontal registers 214A are sequentially transferred in the horizontal direction.

In addition, the electrical charges transferred to the horizontal register 214A located at the end in the horizontal direction are transferred to the summing gate 215. Therefore, the previously transferred electrical charges and the currently transferred electrical charges are stored in the summing gate 215.

The control unit 220 further applies, to the pulse line L2, the pulse to transfer electrical charges stored in the horizontal registers 214A in the horizontal direction. When the pulse is applied to the pulse line L2, the electrical charges stored in the horizontal registers 214A are sequentially transferred in the horizontal direction.

Then, the electrical charges stored in the horizontal register 214A located at the end in the horizontal direction are transferred to the summing gate 215. Therefore, the electrical charges transferred two times before the current transfer, the previously transferred electrical charges, and the currently transferred electrical charges are stored in the summing gate 215. As a result, the electrical charges of 360 ke-×3=“1080 ke-” are input to the summing gate 215.

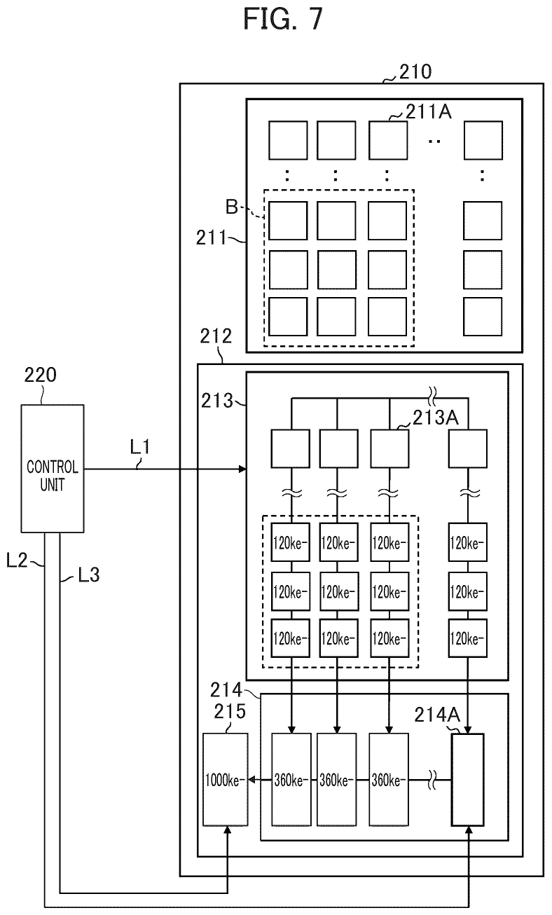

However, as described above, the saturation electrical charge amount of the summing gate 215 is “1000 ke-”, the amount the electrical charges of “1080 ke-” transferred to the summing gate 215 exceeds the saturation electrical charge amount of the summing gate 215. Therefore, as illustrated in FIG. 7, the amount of electrical charges output from the summing gate 215 is “1000 ke-”. Thereafter, the control unit 220 outputs the electrical charges from the summing gate 215 to the conversion unit 230 (see FIG. 3) by applying a pulse to the summing gate 215 through the pulse line L3.

When the electrical charges stored in all of the electrical charge storage elements 213A are transferred to the summing gate 215, the shutter 202 can be opened.

### (Binning)

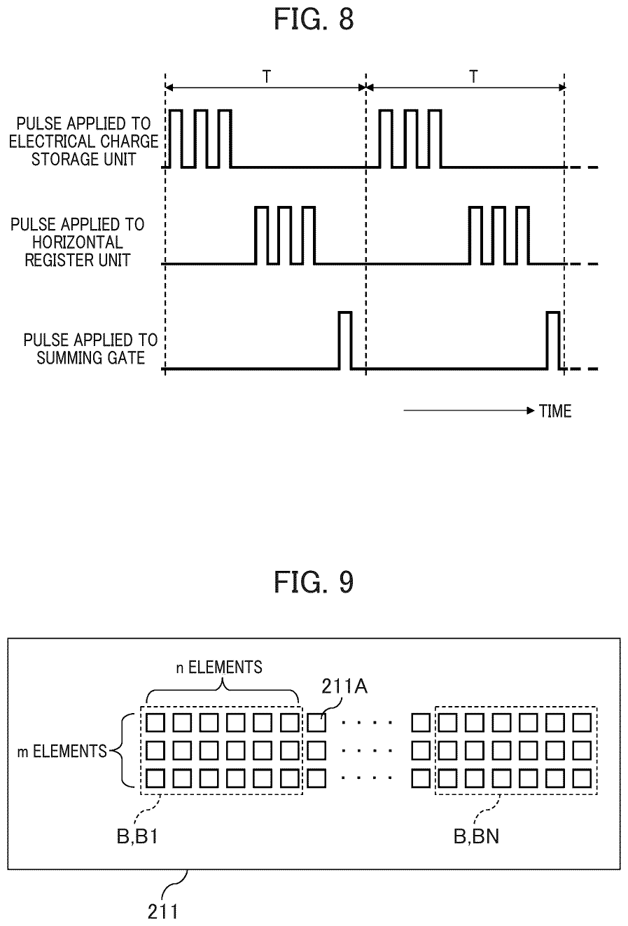

FIG. 8 is a diagram illustrating timings at which the control unit 220 applies the pulses.

FIG. 8 illustrates, from the top of the sheet, the timings at which the pulse is applied to the electrical charge storage unit 213, the timings at which the pulse is applied to the horizontal register unit 214, and the timings at which the pulse is applied to the summing gate 215.

Since the electrical charges corresponding to the plurality of light receiving elements 211A are accumulated in the summing gate 215 by the operation described with reference to FIGS. 5 to 7, the plurality of light receiving elements 211A can be treated as a single light receiving element 211A in a pseudo manner. Treating a plurality of light receiving elements 211A as a single light receiving element 211A in a pseudo manner is referred to as binning, and the light receiving elements 211A integrated in the pseudo manner are referred to as a bin B (refer to FIG. 3).

In the example illustrated in FIGS. 5 to 8, a total of nine light receiving elements 211A, three elements in the vertical direction and three elements in the horizontal direction, are binned into one bin B. Electrical charges are accumulated in the horizontal registers 214A and the summing gate 215 for each of the light receiving elements 211A corresponding to the bin B. That is, in the example illustrated in FIG. 8, after the pulse is continuously applied to the electrical charge storage unit 213 three times, the pulse is continuously applied to the horizontal register unit 214 three times. After that, the pulse is applied to the summing gate 215 once. Therefore, the total of nine light receiving elements 211A, three elements in the vertical direction and three elements in the horizontal direction, are binned. The bin B generated by this binning is the bin B illustrated in FIG. 3. A region in which the binning is performed is not limited to the example illustrated in FIGS. 5 to 8. By changing the binning region (making the binning region variable), it is possible to change the sensitivity of the CCD image sensor 210. That is, the size of the bin B is variable.

In the example illustrated in FIG. 8, applying the pulse to the electrical charge storage unit 213 three times, applying the pulse to the horizontal registers 214A three times, and applying the pulse to the summing gate 215 once are regarded as one set (period T), and the set is performed multiple times. Then, the set is repeated until all of electrical charges stored in the electrical charge storage unit 213 are transferred to the horizontal registers 214A.

FIG. 9 is a diagram illustrating an example of a configuration of a generalized bin B

In general, as illustrated in FIG. 9, one bin B can be considered to include m light receiving elements 211A (=electrical charge storage elements 213A) in the vertical direction and n light receiving elements 211A (=electrical charge storage elements 213A) in the horizontal direction. That is, in the example illustrated in FIGS. 3 and 5 to 8, the bin B is formed with m=3 and n=3. Each of bins B1 to BN illustrated in FIG. 9 do not overlap each other. By changing the timings at which the control unit 220 applies the pulse, the magnitudes of the bins B can be changed.

In the measurement unit 20 according to the present example of the first embodiment, the binning is performed to virtually integrate the light receiving elements 211A.

### [Outline of Configuration]

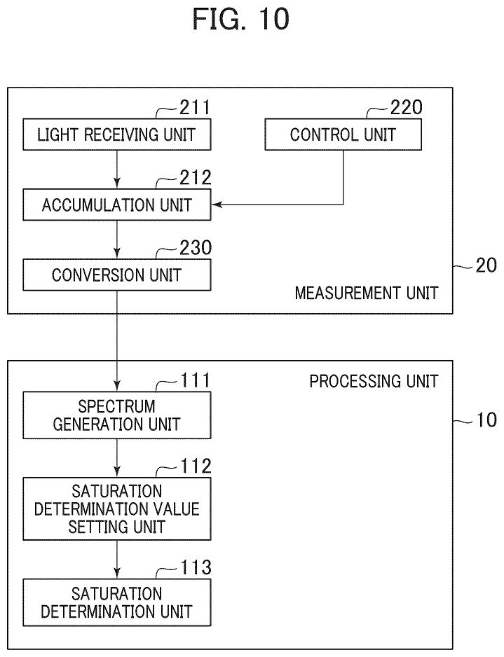

FIG. 10 is a diagram illustrating an outline of the measurement unit 20 and the processing unit 10 according to the first example of the first embodiment.

The control unit 220 issues, to the accumulation unit 212, an instruction to accumulate electrical charges received by the light receiving unit 211. Subsequently, the control unit 220 instructs the conversion unit 230 to convert the electrical charges accumulated in the accumulation unit 212 into a digital signal. By repeating the accumulation and the instruction for the conversion, the bins B (see FIG. 9) are generated. Digital signals corresponding to the respective generated bins B are output to the spectrum generation unit 111 of the processing unit 10. In addition, the spectrum generation unit 111 outputs spectra SP (see FIG. 4) of the input digital signals to the saturation determination value setting unit 112. Further, the saturation determination value setting unit 112 outputs the saturation determination value D30 (see FIG. 4) set based on the spectra SP to the saturation determination unit 113. The saturation determination unit 113 determines, based on the saturation determination value D30, whether saturation has occurred in the digital signals.

Refer to FIG. 3 again.

The electrical charge conversion unit 231 converts the electrical charges accumulated in the summing gate 215 into a voltage corresponding to the number of the electrical charges transferred from the summing gate 215. As a result, the electrical charge conversion unit 231 outputs the converted voltage as an analog signal to the digital conversion unit 232. That is, in the set illustrated in FIG. 8, the electrical charge conversion unit 231 to which the electrical charges have been finally transferred from the summing gate 215 outputs the voltage corresponding to the amount of the transferred electrical charges as the analog signal.

The digital conversion unit 232 convers the analog signal output from the electrical charge conversion unit 231 into a digital signal. The converted digital signal is output to the processing unit 10. In the present example of the first embodiment, a digital signal is referred to as a “signal” as appropriate, and a digital signal intensity that is the intensity of the digital signal is referred to as a “signal intensity” as appropriate.

Refer to FIG. 4 again.

The measurement unit 20 outputs, based on the analysis target sample D10, an analysis target sample signal D11 that is a digital signal (signal) of the analysis target sample D10 using the method described with reference to FIGS. 5 to 8. The output analysis target sample signal D11 has a signal intensity for each bin B in all of frames. The output analysis target sample signal D11 is input to the color conversion unit 103, the spectrum generation unit 111, and the saturation determination unit 113 of the processing unit 10. In addition, the measurement unit 20 performs measurement on the matrix standard D20 in addition to the analysis targe sample D10. Then, the measurement unit 20 outputs a matrix standard signal D21 that is a digital signal of the matrix standard D20 using the method described with reference to FIGS. 5 to 8. The output matrix standard signal D21 has a signal intensity for each bin B in all of the frames. The output matrix standard signal D21 is input to the fluorescence calibration unit 101 of the processing unit 10. It should be noted that the analysis target sample D10 and the matrix standard D20 are separately measured.

The fluorescence calibration unit 101 normalizes the matrix standard signal D21 output from the measurement unit 20 for each of the frames such that the maximum signal intensity is “1”, and outputs the matrix standard signal D21 to the pseudo inverse matrix generation unit 102. The normalized digital signal is referred to as fluorescent spectrum data D22.

Subsequently, the pseudo inverse matrix generation unit 102 acquires the fluorescent spectrum data D22 output from the fluorescence calibration unit 101, and generates a pseudo inverse matrix D23 of the fluorescent spectrum data D22. The generated pseudo inverse matrix D23 is output to the color conversion unit 103.

Then, the color conversion unit 103 acquires the analysis targe sample signal D11 from the measurement unit 20 and acquires the pseudo inverse matrix D23 from the pseudo inverse matrix generation unit 102. Then, the color conversion unit 103 multiplies the analysis target sample signal D11 acquired from the measurement unit 20 by the acquired pseudo inverse matrix D23. By performing this, fluorescent signal data D24 is generated. The color conversion unit 103 outputs the generated fluorescent signal data D24 to the saturation determination unit 113.

Meanwhile, the spectrum generation unit 111 acquires the analysis target sample signal D11 output from the measurement unit 20. Then, the spectrum generation unit 111 generates a spectrum SP of the analysis target sample signal D11.

The saturation determination value setting unit 112 that is a saturation determination processing unit sets the saturation determination value D30 based on the shape of the spectrum SP generated by the spectrum generation unit 111. A method of setting the saturation determination value D30 is described later. The saturation determination value setting unit 112 outputs the set saturation determination value D30 to the saturation determination unit 113. Then, the saturation determination unit 113 that is a saturation determination processing unit adds, based on the saturation determination value D30, a mark indicating whether saturation has occurred in the analysis target sample signal D11 to the analysis target sample signal D11.

### (Process of Setting Saturation Determination Value)

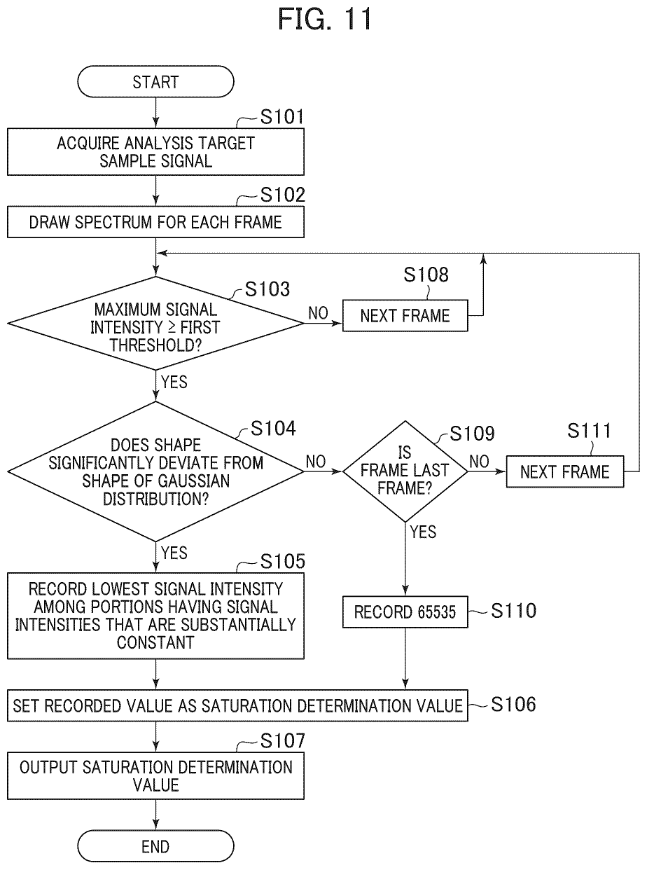

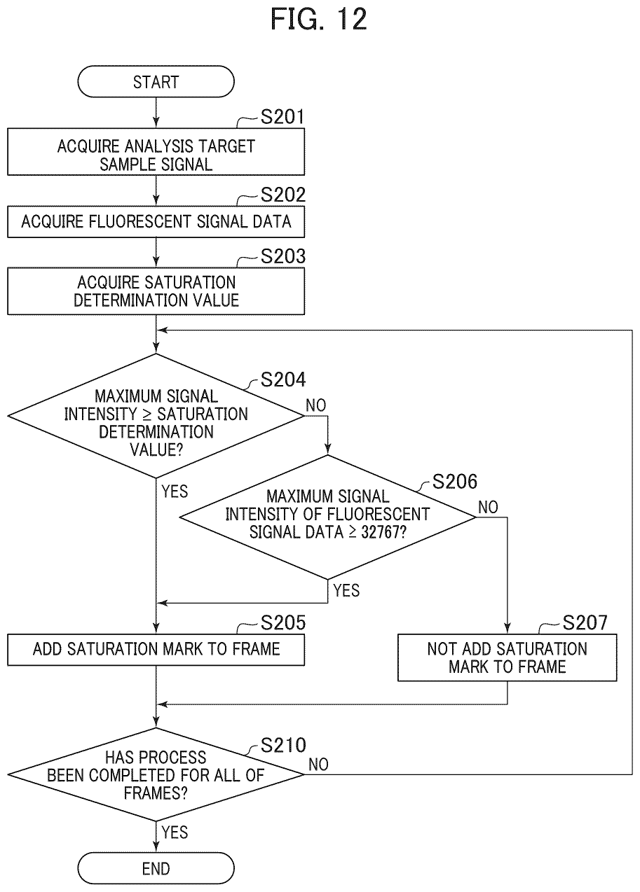

Next, a process procedure of an electrophoresis data processing method according to the first example of the first embodiment will be described with reference to FIGS. 11 and 12.

FIG. 11 is a flowchart illustrating a procedure (process of setting the saturation determination value) according to the first example of the first embodiment.

Refer to FIG. 4 as appropriate.

First, the spectrum generation unit 111 acquires the analysis target sample signal D11 from the measurement unit 20 (S101). In step S101, the spectrum generation unit 111 acquires the analysis target sample signal D11 for all of the frames. In the subsequent processing, the same applies to processing similar to step S101. Step S101 corresponds to a signal acquisition step.

Next, the spectrum generation unit 111 draws (generates) the spectrum SP of the analysis target sample signal D11 for each of the frames (S102). The spectrum generation unit 111 draws, for each of the frames, a graph in which the horizontal axis of the analysis target sample signal D11 indicates a number of a bin B and the vertical axis indicates the signal intensity of the bin B. The graph in which the horizontal axis indicates the number of the bin B and the vertical axis indicates the signal intensity of the bin B is referred to as the spectrum SP. The spectrum SP of the analysis target sample D11 is generated based on a signal intensity obtained as a result of measuring the sample to be analyzed. Step S102 corresponds to a spectrum generation step.

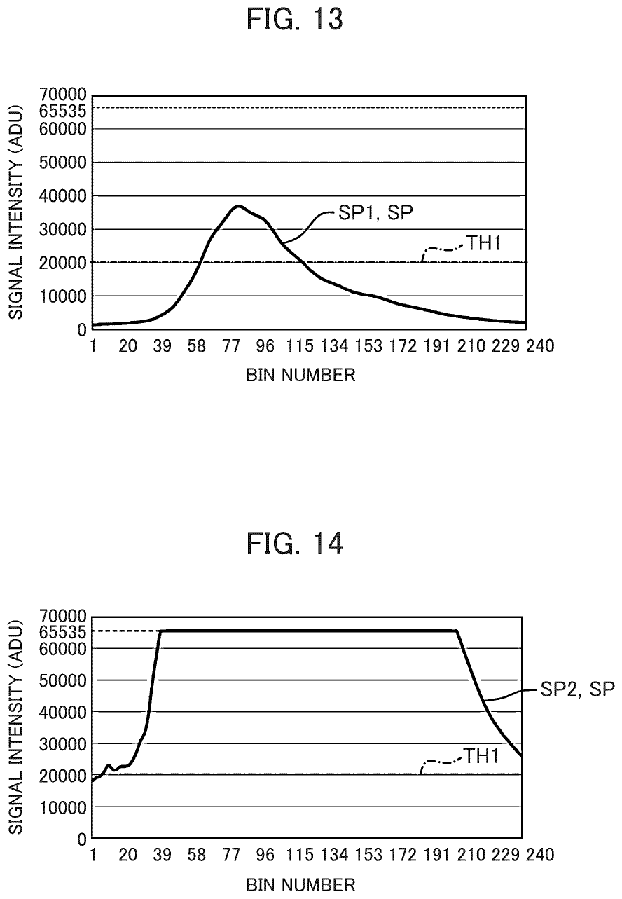

Subsequently, the saturation determination value setting unit 112 selects one frame among the frames. Then, the saturation determination value setting unit 112 determines, for the selected frame, whether the maximum signal intensity of the spectrum SP drawn in step S102 is greater than or equal to a first threshold TH1 (see FIG. 13) (S103). The first threshold TH1 is set by a user in advance. As the first threshold TH1, a value that is sufficiently less than the signal intensity in a case where saturation has occurred in the signal, and is sufficiently greater than the signal intensity in a case where the analysis target sample D10 is not included in the electrophoretic medium M (see FIG. 1) is set. That is, the signal intensity in a case where it is known that saturation has not occurred reliably in the signal is set as the first threshold TH1 in advance. In the present example of the first embodiment, it is assumed that a signal intensity of “20000” (ADU) is set as the first threshold TH1.

In a case where the maximum signal intensity of the spectrum SP is greater than or equal to the first threshold TH1 (S103: Yes), the saturation determination value setting unit 112 determines whether the shape of the spectrum SP significantly deviates from a shape of a Gaussian distribution that is a predetermined shape (S104). Specifically, in step S104, the saturation determination value setting unit 112 calculates the sum of squares of differences between the spectrum SP and the Gaussian distribution. Then, in a case where the sum of the squares of the differences is greater than or equal to a predetermined threshold (threshold different from the first threshold TH1), the saturation determination value setting unit 112 determines that the shape of the spectrum SP significantly deviates from the shape of the Gaussian distribution. The fact that the shape of the spectrum SP significantly deviates from the shape of the Gaussian distribution will be described later. Step S104 corresponds to a saturation determination step.

In a case where the shape of the spectrum SP significantly deviates from the shape of the Gaussian distribution (S104: Yes), the saturation determination value setting unit 112 determines that saturation has occurred in the measurement unit 20, and performs processing in step S105. In step S105, the saturation determination value setting unit 112 records the lowest signal intensity among portions having signal intensities that are substantially constant in the spectrum SP.

Subsequently, the saturation determination value setting unit 112 sets the value of the signal intensity recorded in step S105 as the saturation determination value D30 (S106) and outputs the saturation determination value D30 to the saturation determination unit 113 (S107).

On the other hand, in a case where the maximum signal intensity of the spectrum SP is less than the first threshold TH1 in step S103 (S103: No), the processing unit 10 causes the procedure to proceed to the next frame (S108). Then, the processing unit 10 performs the processing in step S103 and the subsequent steps on the next frame.

In a case where the shape of the spectrum SP does not significantly deviate from the Gaussian distribution in step S104 (S104: No), the saturation determination value setting unit 112 performs processing in step S109. In step S109, the saturation determination value setting unit 112 determines whether the frame to be processed is the last frame. In a case where the frame to be processed is the last frame (S109: Yes), the saturation determination value setting unit 112 records “65535” (ADU) as the signal intensity (S110). The value “65535” (ADU) indicates the signal intensity for the saturation electrical charge amount of the summing gate 215 as described above. That is, in the example illustrated in FIG. 7, the saturation electrical charge amount of the summing gate 215 is “1000 ke-” and the signal intensity corresponding to “1000 ke-” is “65535” (ADU). In step S110, it suffices for the signal intensity corresponding to the saturation electrical charge amount of the summing gate 215 to be recorded, and the signal intensity is not limited to the value “65535” (ADU).

Then, the saturation determination value setting unit 112 sets the value “65535” (ADU) recorded in step S105 as the saturation determination value D30 (S106). That is, in a case where the spectrum SP does not significantly deviate from the shape of Gaussian distribution for all of the frames, the saturation determination value setting unit 112 sets the signal intensity based on the saturation electrical charge amount of the summing gate 215 as the saturation determination value D30.

In a case where the frame to be processed is not the last frame in step S109 (S109: No), the processing unit 10 causes the procedure to proceed to the next frame (S111).

Then, the processing unit 10 performs the processing in step S103 and the subsequent steps.

### (Saturation Determination Process)

Refer to FIG. 4 again. As described above, the Saturation determination unit 113 acquires the analysis target sample signal D11 from the measurement unit 20. In addition, the saturation determination unit 113 acquires the fluorescent signal data D24 from the color conversion unit 103. Further, the saturation determination unit 113 acquires the saturation determination value D30 from the saturation determination value setting unit 112. Then, the saturation determination unit 113 determines whether saturation has occurred in the frame to be processed, based on the acquired analysis target sample signal D11, the acquired fluorescent signal data D24, and the acquired saturation determination value D30. The process performed by the saturation determination unit 113 will be described below in detail.

FIG. 12 is a flowchart illustrating a procedure of the saturation determination process by the saturation determination unit 113 according to the first example of the first embodiment. Refer to FIG. 4 as appropriate.

The analysis target sample signal D11 used with reference to FIG. 12 is the analysis target sample signal D11 used with reference to FIG. 11.

First, the saturation determination unit 113 acquires the analysis target sample signal D11 from the measurement unit 20 (S201).

Subsequently, the saturation determination unit 113 acquires the fluorescent signal data D24 from the color conversion unit 103 (S202).

Subsequently, the saturation determination unit 113 acquires the saturation determination value D30 from the saturation determination value setting unit 112 (S203). In steps S201 to S203, the processing is performed on all of the frames. In addition, the fluorescent signal data D24 is acquired for each of the frames as well.

Next, the saturation determination unit 113 determines whether the maximum signal intensity of the analysis target sample signal D11 in the frame to be analyzed is greater than or equal to the saturation determination value D30 (S204).

In a case where the maximum signal intensity is greater than or equal to the saturation determination value D30 (S204: Yes), the saturation determination unit 113 adds a saturation mark to the frame (S205).

In a case where the maximum signal intensity is less than the saturation determination value D30 in step S204 (S204: No), the saturation determination unit 113 performs processing in step S206.

In step S206, the saturation determination unit 113 determines whether the maximum signal intensity of the fluorescent signal data D24 in the frame to be processed is greater than or equal to “32767” (relative fluorescence unit (RFU) ). In step S206, it is determined whether saturation has occurred in the fluorescent signal data D24. Basically, when the analysis target sample signal D11 is less than the saturation determination value D30, the fluorescent signal data D24 is not saturated. However, depending on the processing by the color conversion unit 103, the fluorescent signal data D24 may be saturated although the analysis target sample signal D11 is less than the saturation determination value D30. Step S206 is performed to avoid such a case. The value “32767” (RFU) is half the saturation electrical charge amount of the summing gate 215. The reason why the saturated signal intensity of the fluorescent signal data D24 is half the saturation electrical charge amount of the summing gate 215 is that the fluorescent signal data D24 has positive and negative values.

In a case where the maximum signal intensity of the fluorescent signal data D24 in the frame to be processed is greater than or equal to “32767” (RFU) (S206: Yes), the saturation determination unit 113 performs processing in step S205. In step S205, the saturation determination unit 113 adds a saturation mark to the frame to be processed.

In a case where the maximum signal intensity of the fluorescent signal data D24 in the frame to be processed is less than “32767” (RFU) (S206: No), the saturation determination unit 113 performs processing in step S207. In step S207, the saturation determination unit 113 does not add a saturation mark to the frame to be processed. That is, in step S207, the saturation determination unit 113 does not perform any processing.

Subsequently, after the processing in step S205 or S207 is performed, the saturation determination unit 113 determines whether the process has been completed for all of the frames (S210).

In a case where the process has not been completed for all of the frames (S210: No), the processing unit 10 performs the processing in step S204 and the subsequent steps.

In a case where the process has been completed for all of the frames (S210: Yes), the saturation determination unit 113 ends the saturation determination process.

As described above, in a case where the intensity of the signal acquired from the measurement unit 20 exceeds the saturation determination value D30, the saturation determination unit 113 adds, to the acquired signal, a mark indicating that saturation has occurred in the signal.

### [Operation]

Subsequently, operation in the first example of the first embodiment will be described with reference to FIGS. 13 to 15.

FIGS. 13, 14, 15, and 17 illustrate spectra SP when the number of bins B is 240. In addition, FIGS. 13, 14, 15, and 17 illustrate the spectra SP of the analysis target sample signal D11 drawn in step S102 illustrated in FIG. 11.

The first threshold TH1 is used in step S103 illustrated in FIG. 11. In the examples illustrated in FIGS. 13, 14, and 15, it is assumed that “20000” (ADU) is set as the first threshold TH1.

Dispersed light is incident on light receiving elements 211A constituting each of bins B. Therefore, the light having different wavelengths is incident as the signal intensity in each of the bins B. In each of the spectra SP illustrated in FIGS. 13, 14, 15, and 17, the signal intensity corresponding to each of the bins B is the signal intensity of the wavelength light incident on the bin B. In each of the examples illustrated in FIGS. 13, 14, 15, and 17, the wavelength becomes shorter toward the left side of the sheet, and longer toward the right side of the sheet.

FIG. 13 is a diagram illustrating an example of a spectrum SP1 in which saturation has not occurred.

Referring to FIG. 13, the maximum signal intensity in the spectrum SP1 (SP) is greater than or equal to the first threshold TH1 (the signal intensity of “20000” (ADU) in the example illustrated in FIG. 13). Therefore, “Yes” is determined in step S103 illustrated in FIG. 11, and the saturation determination value setting unit 112 causes the procedure to proceed to the processing in step S104 illustrated in FIG. 11. Subsequently, in step S104 illustrated in FIG. 11, the saturation determination value setting unit 112 determines whether the shape of the spectrum SP1 does not significantly deviate from the shape of the Gaussian distribution. Referring to FIG. 13, the spectrum SP1 is a distribution that does not significantly deviate from the shape of the Gaussian distribution. Therefore, the saturation determination value setting unit 112 determines “No” in step S104. That is, the saturation determination value setting unit 112 determines that saturation has not occurred in the frame, and causes the procedure to proceed to step S109 illustrated in FIG. 11. Examples in which a spectrum SP significantly deviates from the shape of the Gaussian distribution will be described with reference to FIGS. 14, 15, and 17.

FIG. 14 is a diagram illustrating an example of a spectrum SP2 (SP) when saturation has occurred in the summing gate 215.

Referring to FIG. 14, the maximum signal intensity is greater than or equal to the first threshold TH1 (the signal intensity of “20000” (ADU) in the example illustrated in FIG. 14), the saturation determination value setting unit 112 determines “Yes” in step S103 illustrated in FIG. 11, and causes the procedure to proceed to the processing in step S104 illustrated in FIG. 11. In FIG. 14, the spectrum SP2 (SP) has a flat shape at its top portion, and thus the shape of the spectrum SP2 significantly deviates from the shape of the Gaussian distribution. Therefore, the saturation determination value setting unit 112 determines “Yes” in step S104 illustrated in FIG. 11, and causes the procedure to proceed to step S105 illustrated in FIG. 11. That is, the saturation determination value setting unit 112 determines that saturation has occurred. Then, the saturation determination value setting unit 112 records the lowest signal intensity among portions having signal intensities that are substantially constant in step S105. In the example illustrated in FIG. 14, the portions having signal intensities that are constant are only a top portion of the spectrum SP2. Therefore, the saturation determination value setting unit 112 records the signal intensity (“65535” (ADU) in the example illustrated in FIG. 14) of the top portion of the spectrum SP2. Then, the saturation determination value setting unit 112 sets the recorded value as the saturation determination value D30 (S106 in FIG. 11). Thereafter, the saturation determination value setting unit 112 outputs the set saturation determination value D30 to the saturation determination unit 113 (S107 in FIG. 11). For example, the portions having signal intensities that are substantially constant are determined as a portion in which a difference between signal intensities of adjacent bins B is in a predetermined range.

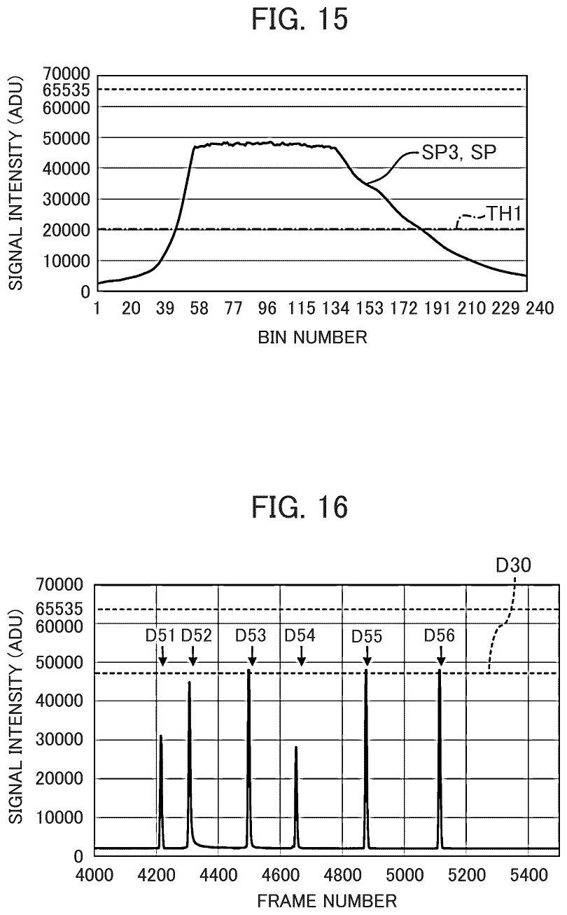

FIG. 15 is a diagram illustrating an example of a spectrum SP3 (SP) in which saturation has occurred in an electrical charge storage element 213A.

Referring to the example illustrated in FIG. 15, the maximum signal intensity is greater than or equal to the first threshold TH1 (signal intensity of “20000” (ADU) in the example illustrated in FIG. 15), and thus the saturation determination value setting unit 112 determines “Yes” in S103 illustrated in FIG. 11. In addition, since the shape of the spectrum SP3 (SP) illustrated in FIG. 15 significantly deviates from the shape of the Gaussian distribution, the saturation determination value setting unit 112 determines “Yes” in step S104 illustrated in FIG. 11. That is, the saturation determination value setting unit 112 determines that saturation has occurred, and performs the processing in S105 illustrated in FIG. 11. In step S105, the saturation determination value setting unit 112 records the lowest signal intensity among portions having signal intensities that are substantially constant. In the example illustrated in FIG. 15, the portions having signal intensities that are substantially constant are only a top portion of the spectrum SP3. Therefore, in step S105 illustrated in FIG. 11, the saturation determination value setting unit 112 records, as the saturation determination value D30, about “48000” (ADU) that is a signal intensity of the top portion of the spectrum SP3.

FIG. 16 is a diagram illustrating an example of an electrophoretic image.

FIG. 16 illustrates a graph in which the horizontal axis indicates a frame number and the vertical axis indicates the maximum signal intensity of the frame. As illustrated in FIG. 16, the graph in which the horizontal axis indicates the frame number and the vertical axis indicates the maximum signal intensity of the frame is referred to as an electrophoretic image. The horizontal axis corresponds to time. FIG. 16 illustrates frame numbers from “4000” to “5500”.

In the example illustrated in FIG. 16, peaks D51 to D56 appear in order from the left side on the sheet. The saturation determination unit 113 determines, based on the saturation determination value D30 set by the saturation determination value setting unit 112, whether saturation has occurred in each of frames. In step S203 illustrated in FIG. 12, the saturation determination unit 113 acquires the saturation determination value D30 output by the saturation determination value setting unit 112. In the example illustrated in FIG. 16, it is assumed that about “48000” (ADU) is set as the saturation determination value D30. In the example illustrated in FIG. 16, the three peaks D53, D55, and D56 reach the saturation determination value D30 (about “48000” (ADU) ) (“Yes” in S204 illustrated in FIG. 12). Therefore, the saturation determination unit 113 determines that saturation has occurred in frames having the peaks D53, D55, and D56. Therefore, the saturation determination unit 113 adds a saturation mark to the frames having the peaks D53, D55, and D56 in step S205 illustrated in FIG. 12.

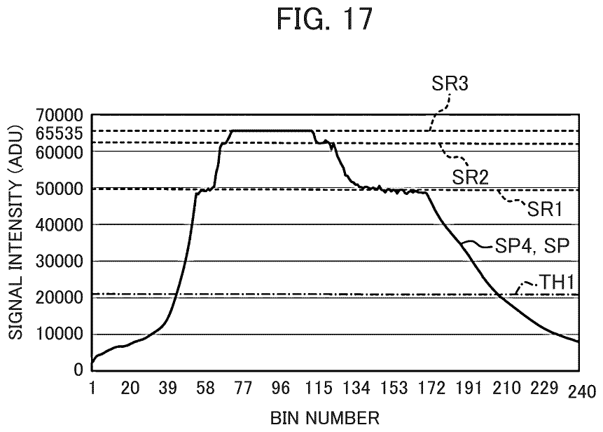

FIG. 17 is a diagram illustrating an example of a spectrum SP4 (SP) according to the first example of the first embodiment.

FIG. 17 illustrates the spectrum SP4 (SP) drawn in step S102 illustrated in FIG. 11. In the spectrum SP4 illustrated in FIG. 17, the signal intensity is constant at a signal intensity of about “48000” (ADU) (first stage saturation: reference sign SR1) as in FIG. 15. However, in the spectrum SP illustrated in FIG. 17, the signal intensity exceeds the first stage saturation (reference sign SR1: signal intensity of about “48000”), and becomes constant again at a signal intensity of about “60000” (ADU) (second stage saturation: reference sign SR2). In addition, in the spectrum SP illustrated in FIG. 17, the signal intensity exceeds the second stage saturation (reference sign SR2: signal intensity of about “60000” (ADU), and becomes constant again at a signal intensity of “65535” (ADU) (third state saturation: reference sign SR3). That is, in the spectrum SP illustrated in FIG. 17, saturation occurs at a plurality of stages (three stages in the example illustrated in FIG. 17).

In FIG. 15, a reliable value is a signal intensity of about “48000” (ADU) that is the first stage saturation (reference sign SR1). That is, as the saturation determination value D30, it is desirable to set a signal intensity as low as possible. In step S105, the lowest signal intensity among portions having signal intensities that are substantially constant is recorded. When the spectrum SP4 as illustrated in FIG. 15 is obtained by this processing, the saturation determination value setting unit 112 records the signal intensity of “48000” (ADU) indicated by reference sign SR1 as the saturation determination value D30. Therefore, the saturation determination value setting unit 112 can record a reliable saturation determination value D30.

### [Effects]

In Patent Literature 1, it is determined that saturation has occurred only when the signal intensity is greater than or equal to “65535” (ADU) (signal intensity based on the saturation electrical charge amount of the summing gate 215). However, in the method described in Patent Literature 1, when the spectrum SP3 as illustrated in FIG. 15 is obtained, it is not possible to determine whether saturation has occurred. In addition, when the spectrum SP4 as illustrated in FIG. 17 is obtained, in the method in Patent Literature 1, a determination value for detecting whether saturation has occurred is used only for reference sign SR3. In the technique described in Patent Literature 1, reliable reference sign SR1 is not used as a determination value for detecting whether saturation has occurred. The same applies to the technique described in Patent Literature 2.

However, according to the first example of the first embodiment, the saturation determination value setting unit 112 determines whether the shape of the spectrum SP significantly deviates from the shape of the Gaussian distribution (S104 illustrated in FIG. 11). Therefore, the saturation determination value setting unit 112 sets the signal intensity (saturation determination value D30) in a case where saturation has occurred (S106 illustrated in FIG. 11). Accordingly, even when the spectrum SP3 illustrated in FIG. 15 is obtained, it is possible to obtain an appropriate saturation determination value D30.

In the flowchart illustrated in FIG. 11, the saturation determination value setting unit 112 determines whether the shape of the spectrum SP significantly deviates from the Gaussian distribution (S104). In addition, the saturation determination value setting unit 112 records the lowest signal intensity among the portions having signal intensities that are substantially constant in the spectrum SP (S105). Since this processing is performed, it is possible to set the signal intensity corresponding to reference sign SR1 as the saturation determination value D30 even when the spectrum SP4 in which saturation has occurred at the plurality of stages as illustrated in FIG. 17 is obtained.

The amount of electrical charges that cause saturation varies depending on the size of a bin B. In addition, whether saturation has occurred varies depending on the saturation electrical charge amount of each of the light receiving elements 211A.

The reason why the saturation determination value D30 varies depending on the CCD image sensor 210 is that the saturation electrical charge amounts of the electrical charge storage elements 213A, the horizontal registers 214A, and the summing gate 215 vary depending on the CCD image sensor 210.

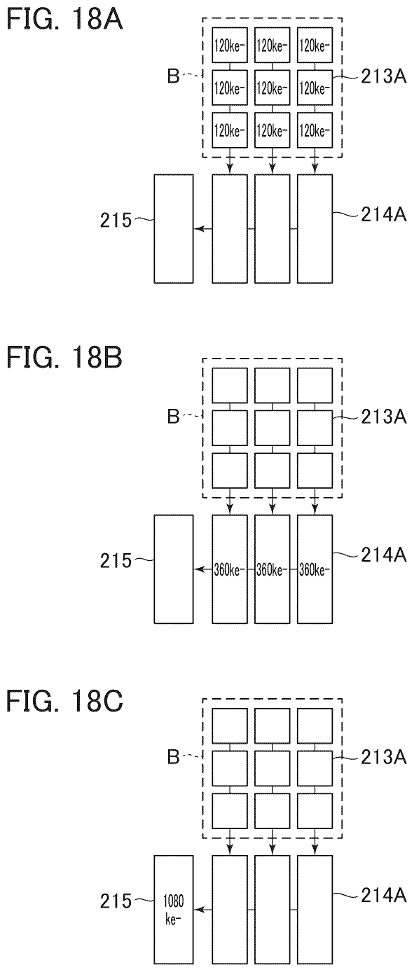

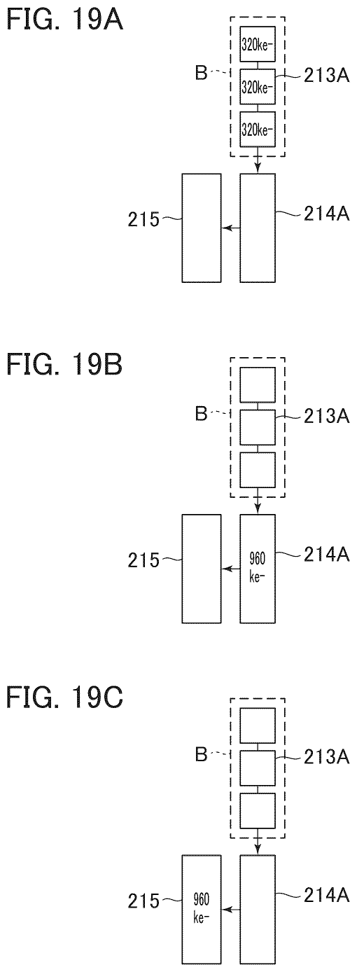

Next, an example in which whether saturation has occurred varies due to a change in the size of a bin B will be described with reference to FIGS. 18A to 19C.

FIGS. 18A to 18C are schematic diagrams illustrating a case where saturation has occurred in a case where nine light receiving elements 211A constitute a bin B.

In FIGS. 18A to 18C, thin arrows indicate a direction in which electrical charges are transferred. In addition, time passes in the order of FIGS. 18A to 18C. Further, as in the description with reference to FIGS. 5 to 7, it is assumed that the saturation electrical charge amount of each of the electrical charge storage elements 213A is “320 ke-” and the saturation electrical charge amount of the summing gate 215 is “1000 ke-”.

It is assumed that the light receiving elements 211A (see FIG. 3) are irradiated with light, and electrical charges of “120 ke-” are accumulated in each of the electrical charge storage elements 213A corresponding to the light receiving elements 211A (FIG. 18A). In this case, saturation has not occurred in the electrical charge storage elements 213A. Electrical charges stored in each of the electrical charge storage elements 213A are transferred to the horizontal registers 214A. When the electrical charges in all of the electrical charge storage elements 213A in the bin B are transferred to the horizontal registers 214A, the electrical charges of “360 ke-” are stored in each of the horizontal registers 214A as illustrated in FIG. 18B. As described with reference to FIGS. 5 to 7, the electrical charges stored in the horizontal registers 214A are transferred to the summing gate 215. When all of the electrical charges in the horizontal registers 214A in: the bin B are transferred to the summing gate 215, the electrical charges of “1080 ke-” are stored in the summing gate 215 as illustrated in FIG. 18C. Since the saturation electrical charge amount of the summing gate 215 is “1000 ke-”, saturation has occurred in the summing gate 215. That is, in the example illustrated in FIGS. 18A to 18C, saturation has not occurred in the electrical charge storage elements 213A, and the saturation has occurred in the summing gate 215.

Next, a case where saturation has occurred in the electrical charge storage elements 213A and saturation has not occurred in the summing gate 215 will be described with reference to FIGS. 19A to 19C.

Meanwhile, a case where three light receiving elements 211A constitute a bin B in a vertical direction will be described with reference to FIGS. 19A to 19C. This one bin B can be implemented by applying the pulse to the electrical charge storage unit 213 three times and applying the pulse to the horizontal register unit 214 once. That is, the bin B in FIGS. 19A to 19C is set to be smaller than that in FIGS. 18A to 18C.

In FIGS. 19A to 19C, thin arrows indicate the directions in which electrical charges are transferred. In addition, time passes in the order of FIGS. 19A to 19C.

Further, in FIGS. 19A to 19C, it is assumed that the saturation electrical charge amount of the summing gate 215 is “1000 ke-” as in the description with reference to FIGS. 5 to 7. Further, in FIGS. 19A to 19C, as described above, it is assumed that the saturation electrical charge amount of each of the electrical charge storage element 213A is “320 ke-”.

It is assumed that the light receiving elements 211A are irradiated with strong light. The strong light indicates light strong enough to generate electrical charges in the light receiving elements 211A that exceed the saturation electrical charge amount of each of the electrical charge storage elements 213A. In this case, as illustrated in FIG. 19A, the saturation electrical charge amount of each of the electrical charge storage elements 213A corresponding to the light receiving elements 211A is “320 ke-”, and thus electrical charges of “320 ke-” are stored in each of the electrical charge storage elements 213A. The electrical charges stored by the above-described procedure are transferred from the electrical charge storage unit 213 to the horizontal registers 214A. When the electrical charges stored in all of the electrical charge storage elements 213A in the bin B are transferred to the horizontal registers 214A, the electrical charges of “960 ke-” are stored in each of the horizontal registers 214A (see FIG. 19B). Further, the electrical charges stored in the horizontal registers 214A are transferred to the summing gate 215 (see FIG. 19C). As a result, the electrical charges of “960 ke-” are accumulated in the summing gate 215. As described above, the saturation electrical charge amount of the summing gate 215 is “1000 ke-”, and thus saturation has not occurred in the summing gate 215 in the example illustrated in FIG. 19C. That is, in the example illustrated in FIGS. 19A to 19C, saturation has occurred in the electrical charge storage elements 213A and saturation has not occurred in the summing gate 215.

As described above, in a state in which the bin B is set to be small, when the light receiving elements 211A are irradiated with the strong light, a phenomenon occurs in which saturation has occurred in the electrical charge storage elements 213A and saturation has not occurred in the summing gate 215. In such a case, an obtained spectrum SP is the spectrum SP3 as illustrated in FIG. 15. In the existing techniques including Patent Literatures 1 and 2, when a phenomenon occurs in which saturation has occurred in electrical charge storage elements 213A and saturation has not occurred in a summing gate 215, the saturation cannot be detected. According to the first example of the first embodiment, whether saturation has occurred is determined based on the shape of the spectrum SP. By performing this, the occurrence of saturation can be detected even when Saturation has occurred in the electrical charge storage elements 213A and saturation has not occurred in the summing gate 215, as illustrated in FIGS. 19A to 19C.

According to the first example of the first embodiment, as in the examples illustrated in FIGS. 18A to 18C and 19A to 19C, even when the size of the bin B is changed and the saturation charge amounts are changed, it is possible to determine whether saturation has occurred in the analysis target sample signal D11. In addition, according to the first example of the first embodiment, even in a case where the CCD image sensor 210 having a small saturation electrical charge amount is used, it is possible to determine whether saturation has occurred. That is, since the saturation electrical charge amount of each of the electrical charge storage elements 213A is small, even in a case where the CCD image sensor 210 that causes the electrical charge storage elements 213A to be saturated is used, it is possible to determine whether saturation has occurred. That is, regardless of a difference between saturation electrical charge amounts of measurement units 20 used, it is possible to determine whether saturation has occurred. Specifically, even when the saturation electrical charge amounts of the CCD image sensor 210 and the horizontal registers 214A are changed due to replacement of the measurement unit 20 or the like, it is possible to determine whether saturation has occurred without the need to check the characteristics of the CCD image sensor 210 and the horizontal registers 214A.

As described above, according to the first example of the first embodiment, it is possible to prevent a signal that is actually saturated from being erroneously recognized as not being saturated. Therefore, according to the first example of the first embodiment, it is possible to eliminate a possibility that a signal that is actually saturated is erroneously recognized as not being saturated and is used for diagnosis or the like. That is, according to the first example of the first embodiment, it is possible to improve the accuracy of determining whether saturation has occurred in the measurement unit of the electrophoresis device.

In addition, according to the first example of the first embodiment, it is possible to determine whether saturation has occurred, based on comparison with the shape of the Gaussian distribution even if the shape of the spectrum SP of the matrix standard D20 is not known in advance.

In addition, the method described in the first example of the first embodiment can be implemented by changing a program of the processing unit 10. Therefore, since it is possible to implement the method described in the first example of the first embodiment without changing the configuration of the measurement unit 20, it is possible to save the cost.

Further, according to the method described in the first example of the first embodiment, even if the specifications of the CCD image sensor 210 newly purchased are not known, it is possible to determine whether saturation has occurred.

### Second Example of First Embodiment

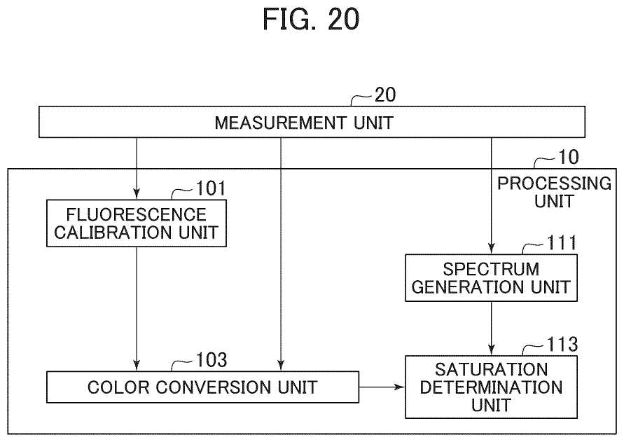

Subsequently, a second example of the first embodiment of the present invention will be described with reference to FIGS. 20 to 22.

In the first example of the first embodiment, in the saturation determination value setting unit 112, the saturation determination value D30 is set, and whether saturation has occurred is determined based on whether the maximum signal intensity of the analysis target sample signal D11 is greater than or equal to the saturation determination value D30.

Meanwhile, in the second example of the first embodiment, the spectrum generation unit 111 draws a spectrum SP (see FIG. 13) for all of the frames of the analysis target sample signal D11. Then, the saturation determination unit 113 determines, based on the shape of the spectrum SP, whether saturation has occurred in each of the frames.

### [System Configuration]

FIG. 20 is a diagram illustrating an outline of a configuration of an electrophoresis device 1 according to the second example of the first embodiment.

As illustrated in FIG. 20, the electrophoresis device 1 includes a measurement unit 20 and a processing unit 10.

The processing unit 10 mainly includes a fluorescence calibration unit 101, a color conversion unit 103, a spectrum generation unit 111, and a saturation determination unit 113.

The fluorescence calibration unit 101 and the color conversion unit 103 perform the same processing as that in the first example of the first embodiment.

Processing performed by the spectrum generation unit 111 and the saturation determination unit 113 will be described later in the operation section.

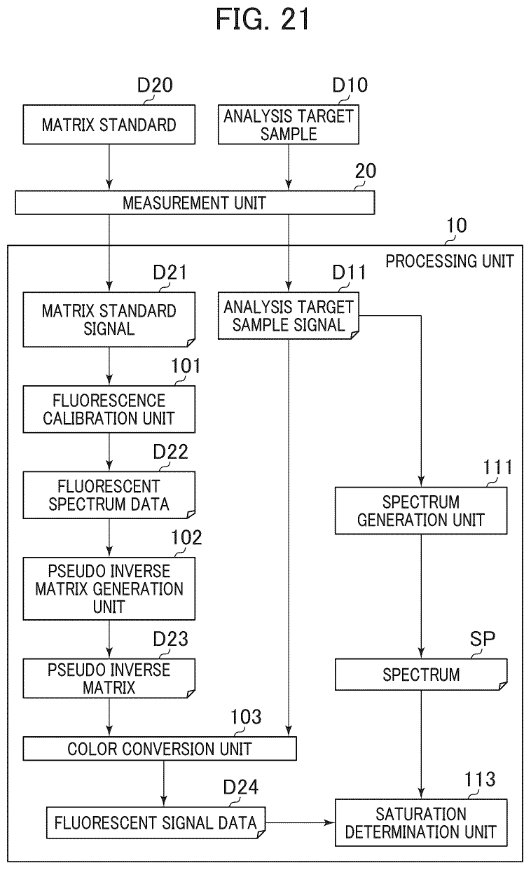

FIG. 21 is a diagram illustrating an example of a detailed configuration of the processing unit 10 according to the second example of the first embodiment.

The configuration illustrated in FIG. 21 is different from the configuration illustrated in FIG. 4 in that the saturation determination value setting unit 112 is omitted.

As illustrated in FIG. 21, the measurement unit 20 outputs the analysis target sample signal D11 from the analysis target sample D10 to the processing unit 10. In addition, the measurement unit 20 outputs a matrix standard signal D21 derived from the matrix standard D20 to the processing unit 10.

Then, the fluorescence calibration unit 101 of the processing unit 10 acquires a digital signal of the matrix standard D20. In addition, the color conversion unit 103 acquires the digital signal of the matrix standard D20 and the analysis target sample signal D11. Further, the spectrum generation unit 111 acquires the analysis target sample signal D11.

The operation of the fluorescence calibration unit 101 is similar to that in the first example of the first embodiment.

The pseudo inverse matrix generation unit 102 acquires fluorescent spectrum data D22 from the fluorescence calibration unit 101 and generates a pseudo inverse matrix D23 of the fluorescent spectrum data D22.

Then, the color conversion unit 103 multiplies the pseudo inverse matrix D23 generated by the pseudo inverse matrix generation unit 102 by the analysis target sample signal D11 acquired from the measurement unit 20. By performing this, fluorescent signal data D24 is generated.

The spectrum generation unit 111 generates a spectrum SP (see FIG. 13) based on the analysis target sample signal D11 acquired from the measurement unit 20.

The saturation determination unit 113 determines, based on the generated spectrum SP and the fluorescent signal data D24, whether saturation has occurred in the analysis target sample signal D11 for each of the frames.

### [Saturation Determination Process]

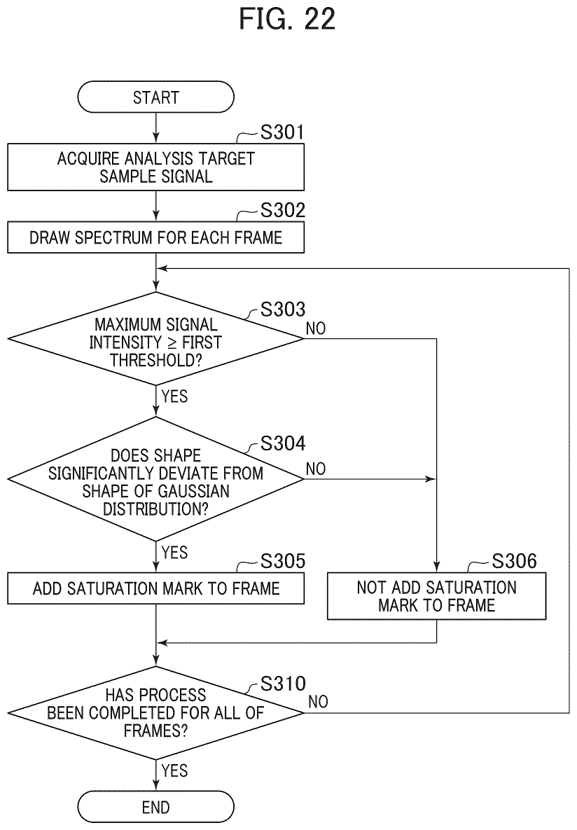

Next, a process procedure of an electrophoresis data processing method according to the second example of the first embodiment will be described with reference to FIG. 22.

FIG. 22 is a flowchart illustrating a procedure of a saturation determination process by the saturation determination unit 113 according to the second example of the first embodiment.

First, the spectrum generation unit 111 acquires the analysis target sample signal D11 from the measurement unit 20 (S301). In step S301, the analysis target sample signal D11 is acquired for all of the frames. Step S301 corresponds to the signal acquisition step.

Next, the spectrum generation unit 111, for all of the frames, draws (generates) a spectrum SP (see FIG. 13) of the analysis target sample signal D11 at each frame (S302). The spectrum SP is a graph in which the horizontal axis indicates a number of a bin B and the vertical axis indicates a signal intensity of the bin B, as described above. Step S302 corresponds to the spectrum generation step.

Subsequently, the saturation determination unit 113 selects one of the frames. Then, the saturation determination unit 113 determines, for the selected frame, whether the maximum signal intensity of the spectrum SP drawn in step S302 is greater than or equal to the first threshold TH1 (see FIG. 13) (S303). The first threshold TH1 is the same as the first threshold TH1 used in the first example of the first embodiment.

In a case where the maximum signal intensity of the spectrum SP is greater than or equal to the first threshold TH1 (S303: Yes), the saturation determination unit 113 determines whether the shape of the spectrum SP drawn in step S302 significantly deviates from the shape of the Gaussian distribution (S304). The determination as to whether the shape significantly deviates from the shape of the Gaussian distribution is performed using the same method as that in step S104 illustrated in FIG. 11. Step S304 corresponds to the saturation determination step.

In a case where the shape of the spectrum SP significantly deviates from the shape of the Gaussian distribution (S304: Yes), the saturation determination unit 113 adds a saturation mark to the frame to be processed (S305).

In a case where the shape of the spectrum SP does not significantly deviate from the shape of the Gaussian distribution (S304: No), the saturation determination unit 113 does not add the saturation mark to the frame to be processed (S306).

In addition, in a case where the maximum signal intensity of the spectrum SP is less than the first threshold TH1 in step S303 (S303: No), the saturation determination unit 113 does not add the saturation mark to the frame to be processed (S306). That is, in step S306, the saturation determination unit 113 does not perform any processing.

After the processing in step S305 or S306, the saturation determination unit 113 determines the process has been completed for all of the frames (S310). In a case where the process has not been completed for all of the frames (S310: No), the processing unit 10 performs the processing in step S303 and the subsequent steps.

In a case where the process has been completed for all of the frames (S310: Yes), the saturation determination unit 113 ends the saturation determination process.

### [Operation]

A case where the spectrum SP drawn in step S302 illustrated in FIG. 22 is the spectrum SP1 as illustrated in FIG. 13 will be described below. In the spectrum SP1 illustrated in FIG. 13, the maximum signal intensity is greater than or equal to the first threshold TH1 (“20000” (ADU) in the example illustrated in FIG. 13). Therefore, the saturation determination unit 113 determines “Yes” in step 303 illustrated in FIG. 22. Then, in step S304, the saturation determination unit 113 determines whether the shape of the spectrum SP does not significantly deviate from the shape of the Gaussian distribution. In the example of the spectrum SP illustrated in FIG. 13, the shape of the spectrum SP does not significantly deviate from the shape of the Gaussian distribution. Therefore, the saturation determination unit 113 determines “No” in step S304 illustrated in FIG. 22. In this procedure, the saturation determination unit 113 determines that saturation has not occurred in the spectrum SP illustrated in FIG. 13. Therefore, in step S306 illustrated in FIG. 22, the Saturation determination unit 113 does not add the saturation mark to the frame to be processed.

Next, a case where the spectrum SP drawn in step S302 illustrated in FIG. 22 is the spectrum SP2 as illustrated in FIG. 14 will be described below.

In the example illustrated in FIG. 14, since the maximum signal intensity is greater than or equal to the first threshold TH1 (“20000” (ADU) ), the saturation determination unit 113 determines “Yes” in step S303 illustrated in FIG. 22. In step S304 illustrated in FIG. 22, the spectrum SP2 illustrated in FIG. 14 has a flat shape at the top portion and significantly deviates from the shape of the Gaussian distribution. Therefore, the saturation determination unit 113 determines “Yes” in step S304 illustrated in FIG. 22. Accordingly, the saturation determination unit 113 determines that saturation has occurred in the frame to be processed. Then, in step S305 illustrated in FIG. 22, the saturation determination unit 113 adds the saturation mark to the frame to be processed.

Next, a case where the spectrum SP drawn in step S302 illustrated in FIG. 22 is the spectrum SP3 as illustrated in FIG. 15 will be described below. In the example illustrated in FIG. 15, the maximum signal intensity is greater than or equal to the first threshold TH1 (“20000” (ADU) ), the saturation determination unit 113 determines “Yes” in step S303 illustrated in FIG. 22. In the example of the spectrum SP3 illustrated in FIG. 15, the top portion has a flat shape. That is, the spectrum SP3 illustrated in FIG. 15 significantly deviates from the shape of the Gaussian distribution, and therefore the saturation determination unit 113 determines “Yes” in step S304 illustrated in FIG. 22. In this manner, the saturation determination unit 113 determines that saturation has occurred in the frame to be processed. The saturation determination unit 113 adds the saturation mark to the frame to be processed in step S305.

In the second example of the first embodiment, the saturation determination unit 113 adds, to the acquires signal, the mark indicating that saturation has occurred when the saturation determination unit 113 determines that saturation has occurred in the measurement unit 20 based on the shape of the spectrum SP.

### [Effects]

According to the second example of the first embodiment, in addition to the effects obtained in the first example of the first embodiment, it is possible to determine whether saturation has occurred while the saturation determination value setting unit 112 is not provided. That is, it is possible to reduce the processing load.

### Third Example of First Embodiment

In the first example of the first embodiment, the analysis target sample signal D11 is used in order for the saturation determination value setting unit 112 to set the saturation determination value D30. In a third example of the first embodiment, instead of this, a saturation reference sample signal D41 that is a digital signal (signal) of a saturation reference sample D40 is used. The saturation reference sample D40 is a sample at a concentration sufficiently high enough to cause saturation in the electrical charge storage unit in order to cause the saturation in an intended manner. That is, when electrophoresis is performed using the saturation reference sample D40, it is possible to almost always determine that saturation has occurred.

### [Processing Unit 10]

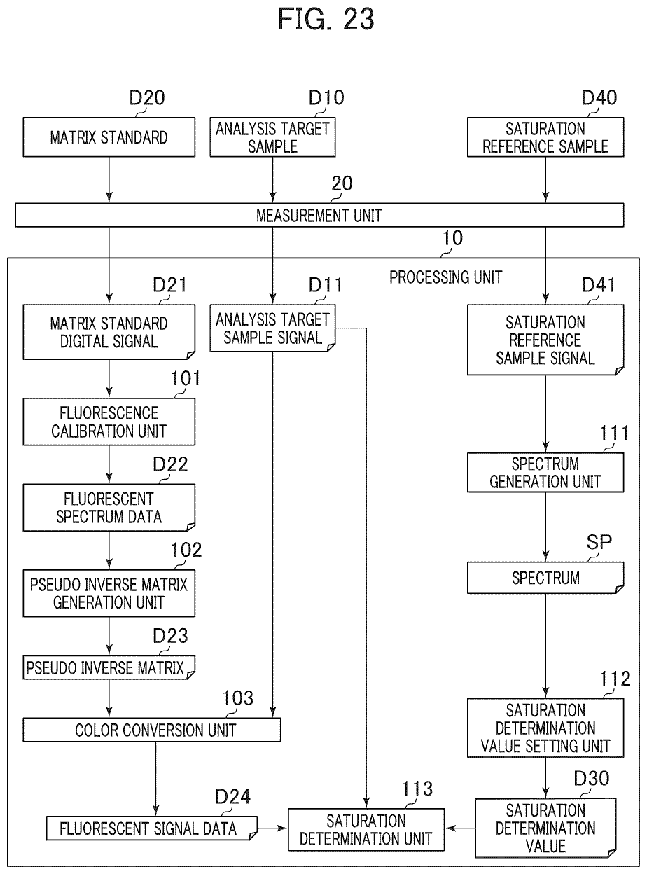

FIG. 23 is a diagram illustrating a configuration of a processing unit 10 according to the third example of the first embodiment. The processing unit 10 illustrated in FIG. 23 is different from the processing unit 10 illustrated in FIG. 4 in that the saturation determination value setting unit 112 sets the saturation determination value D30 using the saturation reference sample signal D41.

In the third example of the first embodiment, the analysis target sample D10, the matrix standard D20, and the saturation reference sample D40 are used. In the third example of the first embodiment, electrophoresis of the saturation reference sample D40 is performed before electrophoresis of the analysis target sample D10 and the matrix standard D20.

Then, the measurement unit 20 outputs, to the processing unit 10, the saturation reference sample signal D41 obtained by the electrophoresis of the saturation reference sample D40.

In addition, the measurement unit 20 outputs the analysis target sample signal D11 to the processing unit 10. Further, the measurement unit 20 outputs the matrix standard signal D21 to the processing unit 10.

The fluorescence calibration unit 101 acquires the matrix standard signal D21. Then, the pseudo inverse matrix generation unit 102 generates the pseudo inverse matrix D23 of the fluorescence spectrum data D22. In addition, the color conversion unit 103 acquires the pseudo inverse matrix D23 generated by the pseudo inverse matrix generation unit 102 and the analysis target sample signal D11 and generates the fluorescent signal data D24 based on these data.

As described above, the operations of the fluorescence calibration unit 101, the pseudo inverse matrix generation unit 102, the color conversion unit 103, and the saturation determination unit 113 are similar to those in the first example of the first embodiment.

The spectrum generation unit 111 acquires the Saturation reference sample signal D41 and generates a spectrum SP of the saturation reference sample signal D41.

The saturation determination value setting unit 112 sets the saturation determination value D30 based on the generated spectrum SP. The saturation determination value setting unit 112 outputs the set saturation determination value D30 to the saturation determination unit 113. The operation performed by the saturation determination value setting unit 112 will be described later.

The saturation determination unit 113 acquires the analysis target sample signal D11, the fluorescent signal data D24, and the saturation determination value D30 set by the saturation determination value setting unit 112. Then, the saturation determination unit 113 adds the saturation mark to the analysis target sample signal D11 based on the saturation determination unit 113, the fluorescent signal data D24.

### [Flowchart ]

Next, a process procedure of an electrophoresis data processing method according to the third example of the first embodiment will be described.

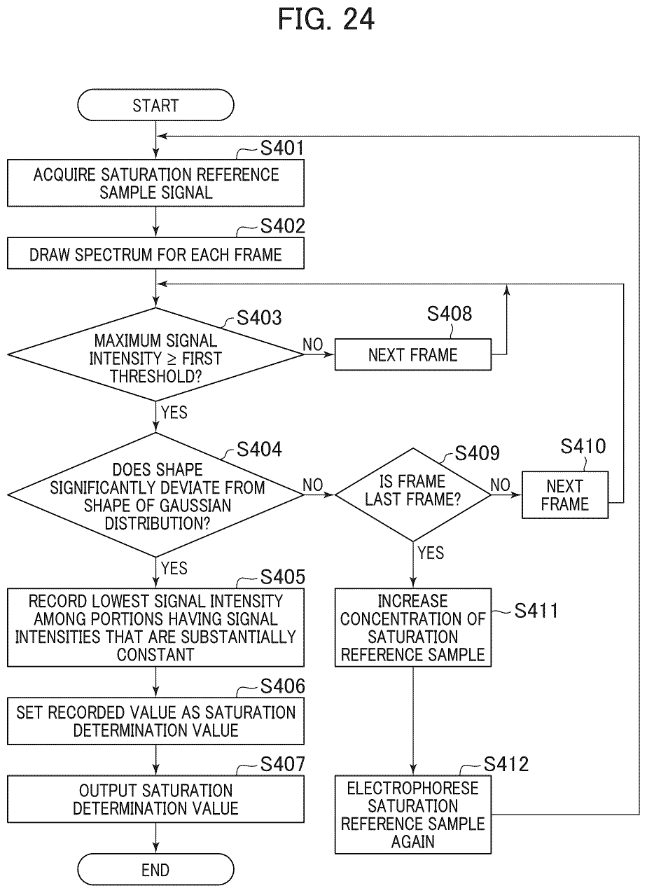

FIG. 24 is a flowchart illustrating a procedure of a saturation determination value setting process by the saturation determination value setting unit 112 according to the third example of the first embodiment. Refer to FIG. 23 as appropriate.

First, the spectrum generation unit 111 acquires the saturation reference sample signal D41 from the measurement unit 20 (S401). A result of binning the saturation reference sample signal D41 is output.

Next, the spectrum generation unit 111 draws a spectrum SP (see FIG. 13) for the saturation reference sample signal D41 acquired in step S401 for each of frames. In the same manner as described above, the spectrum SP is drawn such that the horizontal axis indicates a number of a bin B and the vertical axis indicates the signal intensity of the bin B. The spectrum SP drawn in step S402 is generated based on a signal intensity obtained as a result of measuring the saturation reference sample D40 by the measurement unit 20.

Subsequently, the saturation determination value setting unit 112 selects one frame among the frames. Then, the saturation determination value setting unit 112 determines, for the selected frame, whether the maximum signal intensity of the spectrum SP drawn in step S402 is greater than or equal to the first threshold TH1 (see FIG. 13) (S403). The first threshold TH1 is the same as the first threshold TH1 used in the first example of the first embodiment.

In a case where the maximum signal intensity of the spectrum SP is greater than or equal to the first threshold TH1 (S403: Yes), the saturation determination value setting unit 112 determines whether the shape of the spectrum drawn in step S402 significantly deviates from the shape of the Gaussian distribution (S404). In step S404, the saturation determination value setting unit 112 performs the same processing as that in step S104 in FIG. 11 to determine whether the shape of the spectrum drawn in step S402 significantly deviates from the shape of the Gaussian distribution.

In a case where the shape of the spectrum SP significantly deviates from the shape of the Gaussian distribution (S404: Yes), the saturation determination value setting unit 112 determines that saturation has occurred in the measurement unit 20, and performs processing in step S405. In step S405, the saturation determination value setting unit 112 records the lowest signal intensity among portions having signal intensities that are substantially constant in the spectrum SP.

Subsequently, the saturation determination value setting unit 112 sets the value of the signal intensity recorded in step S405 as the saturation determination value D30 (S406) and outputs the set saturation determination value D30 to the saturation determination unit 113 (S407).

In a case where the maximum signal intensity of the spectrum SP is less than the first threshold TH1 in step S403 (S403: No), the processing unit 10 causes the procedure to proceed to the next frame (S408) and performs the processing in step S403 and the subsequent steps.

In step S404, in a case where the shape of the spectrum SP does not significantly deviate from the shape of the Gaussian distribution (S404: No), the saturation determination value setting unit 112 performs processing in step S409. In step S409, the saturation determination value setting unit 112 determines whether the frame to be processed is the last frame.

In a case where the frame to be processed is not the last frame (S409: No), the processing unit 10 causes the procedure to proceed to the next frame (S410) and performs the processing in step S403 and the subsequent steps. The reason why the process illustrated in FIG. 24 is performed on the plurality of frames is that the timing at which the saturation reference sample D40 is detected (when the saturation reference sample D40 reaches the fluorescence detection position 24) is unclear.

In a case where the frame to be processed is the last frame (S409: Yes), the user increases (thickens) the concentration of the saturation reference sample D40 (S411). Then, in step S411, the user performs again electrophoresis on the saturation reference sample D40 whose concentration has been changed by the user (S412). The fact that “Yes” is determined in step S409 indicates that no saturation has occurred in the saturation reference sample D40 adjusted to cause saturation in an intended manner. Therefore, after the concentration of the saturation reference sample D40 is readjusted, the electrophoresis of the saturation reference sample D40 is performed (S411 and S412). As described above, since the saturation reference sample D40 is a sample at a concentration high enough to cause saturation, the processing in steps S411 and S412 is performed in order to handle a case where it is unlikely that saturation does not occur but saturation has not occurred due to an error or the like of preparation of the saturation reference sample D40.

After the electrophoresis is performed again in step S412, the processing unit 10 performs the processing in step S401 and the subsequent steps.

The operation of the saturation determination unit 113 in the third example of the first embodiment is similar to the process illustrated in FIG. 12, and thus illustration and description thereof are omitted.

### [Operation]

A case where the spectrum SP drawn in step S402 in the third example of the first embodiment is the spectrum SP1 as illustrated in FIG. 13 will be described below. Since the maximum signal intensity of the spectrum SP1 illustrated in FIG. 13 is greater than or equal to the first threshold TH1 (“20000” (ADU) ), the saturation determination value setting unit 112 determines “Yes” in step S403 illustrated in FIG. 24. Then, in step S404 illustrated in FIG. 24, the saturation determination value setting unit 112 determines whether the shape of the spectrum SP significantly deviates from the shape of the Gaussian distribution. Since the shape of the spectrum SP in the example illustrated in FIG. 13 does not significantly deviate from the shape of the Gaussian distribution, the saturation determination value setting unit 112 determines “No” in step S404 illustrated in FIG. 24. That is, the saturation determination value setting unit 112 determines that saturation has not occurred in the frame to be processed.

Subsequently, the saturation determination value setting unit 112 determines whether the frame to be processed is the last frame (S409 illustrated in FIG. 24).

In a case where the frame to be processed is the last frame (S409: Yes), the user changes the concentration of the saturation reference sample D40 (S411) in a high level (thickly), and then the saturation reference sample D40 is electrophoresed again.

In a case where the frame to be processed is not the last frame (S409 illustrated in FIG. 24: No), the processing unit 10 causes the procedure to proceed to the next frame (S410 illustrated in FIG. 24).

A process that is performed by the saturation determination unit 113 is the same as the process illustrated in FIG. 12, and therefore description of the process by the saturation determination unit 113 is omitted in a third example of a second embodiment. However, in the third example of the first embodiment, after the electrophoresis of the analysis target sample D10 is performed again, the process illustrated in FIG. 12 is performed.

In addition, a case where the spectrum SP drawn in step S402 illustrated in FIG. 24 is the spectrum SP3 as illustrated in FIG. 15 will be described below. In the spectrum SP3 illustrated in FIG. 15, the maximum signal intensity is greater than or equal to the first threshold TH1 (“20000” (ADU) in the example illustrated in FIG. 14). Therefore, the saturation determination value setting unit 112 determines “Yes” in step S403 illustrated in FIG. 24. In step S404 illustrated in FIG. 24, the spectrum SP illustrated in FIG. 14 has a flat shape at the top portion, and the shape of the spectrum SP illustrated in FIG. 14 significantly deviates from the shape of the Gaussian distribution. Therefore, the saturation determination value setting unit 112 determines “Yes” in step S404 illustrated in FIG. 24. That is, the saturation determination value setting unit 112 determines that saturation has occurred in the frame to be processed. Then, in step S405 illustrated in FIG. 24, the saturation determination value setting unit 112 records the lowest signal intensity (about “48000” in the example illustrated in FIG. 14) among portions having signal intensities that are substantially constant at the top portion of the spectrum. Then, the saturation determination value setting unit 112 sets the recorded value as the saturation determination value D30 (S406 illustrated in FIG. 24). In addition, the saturation determination value setting unit 112 outputs the set saturation determination value D30 to the saturation determination unit 113 (S407 illustrated in FIG. 24).

### Third Example of First Embodiment: Effects

In the first example of the first embodiment, every time electrophoresis is performed, the setting of the saturation determination value D30 is performed. This is because, in general, the analysis target sample D10 does not often cause saturation, and even if the analysis target sample D10 causes saturation, it does not necessarily indicate that the electrical charge storage elements 213A are saturated. Meanwhile, in the third example of the first embodiment, in addition to the effects obtained in the first example of the first embodiment, the saturation determination value D30 can be approximately determined by electrophoresis the saturation reference sample D40 only once.

In the first embodiment, the spectra SP of the analysis target sample signal D11 and the saturation reference sample signal D41 are compared with the Gaussian distribution with the predetermined shape. Then, in a case where the shapes of the spectra SP deviate from the shape of the Gaussian distribution, the saturation determination value setting unit 112 and the saturation determination unit 113 determine that saturation has occurred in the measurement unit.

### Second Embodiment

In the first embodiment, it is determined whether Saturation has occurred in a frame to be processed, based on whether the shape of a spectrum SP (see FIG. 13) significantly deviates from the shape of the Gaussian distribution. In first to third examples of the second embodiment described below, determination as to whether saturation has occurred in a bin B to be processed is performed based on a change in a slope of a shape of a spectrum SP.

### First Example of Second Embodiment

### [System Configuration]

A system configuration according to a first example of the second embodiment is the same as the configuration illustrated in FIG. 4 except that the saturation determination value setting unit 112 determines, based on a change in a slope of a spectrum SP, whether saturation has occurred. Therefore, illustration of the system configuration according to the first example of the second embodiment is omitted.

### [Flowchart ]

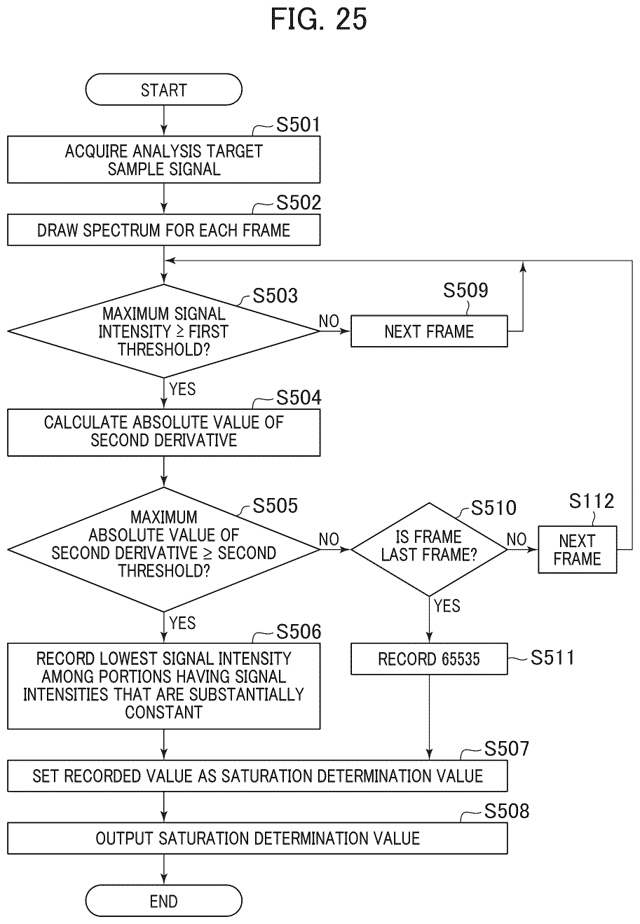

Next, a process procedure of an electrophoresis data processing method according to the first example of the second embodiment will be described with reference to FIG. 25.

FIG. 25 is a flowchart illustrating a procedure of a process of setting a saturation determination value according to the first example of the second embodiment.

Refer to FIG. 4 as appropriate.

First, the spectrum generation unit 111 acquires an analysis target sample signal D11 from the measurement unit 20 (S501). Step S501 corresponds to the signal acquisition step.

Next, the spectrum generation unit 111 draws (generates) a spectrum SP (see FIG. 13) for the analysis target sample signal D11 for each of frames (S502). In step S502, the spectrum SP of the analysis target sample signal D11 is drawn for all of the frames. Step S502 corresponds to the spectrum generation step.

Subsequently, the saturation determination value setting unit 112 selects one frame among the frames. Then, the saturation determination value setting unit 112 determines, for the selected frame, whether the maximum signal intensity of the spectrum SP drawn in step S502 is greater than or equal to the first threshold TH1 (see FIG. 13) (S503). The first threshold TH1 is the same as the first threshold TH1 used in the first example of the first embodiment.

In a case where the maximum signal intensity of the spectrum SP is less than the first threshold TH1 (S503: No), the processing unit 10 causes the procedure to proceed to the next frame (S509) and performs the processing in step S503 and the subsequent steps.

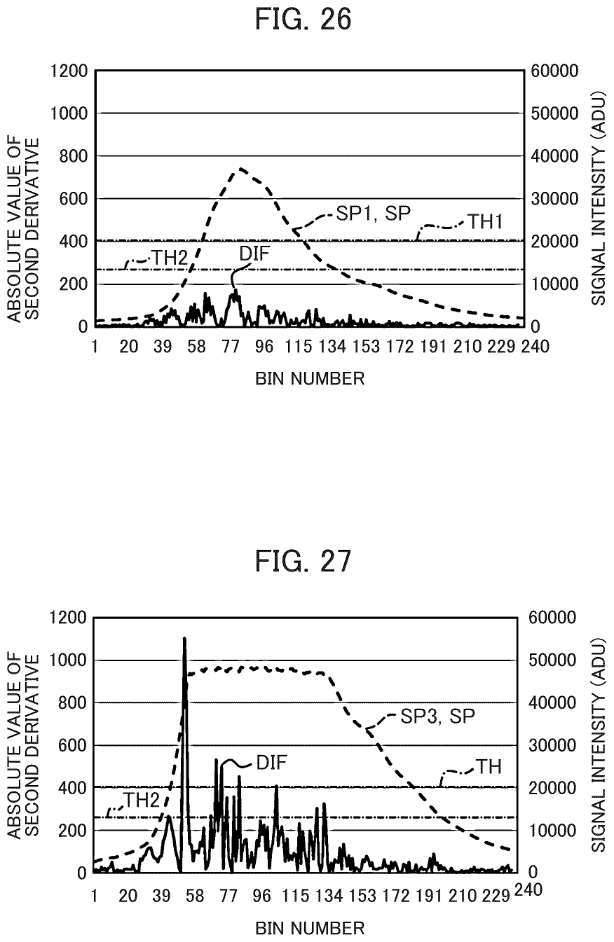

In a case where the maximum signal intensity of the spectrum SP is greater than or equal to the first threshold TH1 (S503: Yes), the saturation determination value setting unit 112 calculates an absolute value DIF (see FIG. 26) of a second derivative of the spectrum SP for the frame to be processed (S504). The absolute value DIF of the second derivative is an absolute value of a value obtained as a result of second-order differentiation of the spectrum SP. In addition, the absolute value DIF of the second derivative is calculated for each of bins B. That is, the absolute value DIF of the second derivative

Subsequently, the saturation determination value setting unit 112 determines whether the maximum value (the maximum absolute value of the second derivative) of the absolute value DIF of the second derivative is greater than or equal to a second threshold TH2 (see FIG. 26) that is a predetermined threshold (S505). As the second threshold TH2, a value that is sufficiently less than the maximum absolute value of the second derivative in a case where saturation has occurred, and is sufficiently greater than the maximum absolute value of the second derivative in a case where saturation has not occurred is set. Step S505 corresponds to the saturation determination step.

In a case where the maximum absolute value of the second derivative is greater than or equal to the second threshold TH2 (S505: Yes; in a case where the maximum absolute value of the second derivative exceeds the predetermined threshold), the saturation determination value setting unit 112 determines that saturation has occurred in the measurement unit 20, and causes the procedure to processing in step S506. In step S506, the saturation determination value setting unit 112 records the lowest signal intensity among portions having signal intensities that are substantially constant in the spectrum SP. That is, in a case where the maximum absolute value of the second derivative is greater than or equal to the second threshold TH2 (S506: Yes), the saturation determination value setting unit 112 determines that saturation has occurred in a signal acquired from the measurement unit 20.

Subsequently, the saturation determination value setting unit 112 sets the value of the signal intensity recorded in step S506 as the saturation determination value D30 (S507), and outputs the set saturation setting value to the saturation determination unit 113 (S508).

In a case where the maximum absolute value of the second derivative is less than the second threshold TH2 (S505: No), the saturation determination value setting unit 112 causes the procedure to proceed to processing in step S510. In step S510, the saturation determination value setting unit 112 determines whether the frame to be processed is the last frame.

In a case where the frame to be processed is the last frame (S510: Yes), the saturation determination value setting unit 112 records the signal intensity of “65535” (ADU) (S511).

Then, the saturation determination value setting unit 112 sets, as the saturation determination value D30, “65535” (ADU) that is the value recorded in step S511 (S507).

Thereafter, the saturation determination value setting unit 112 outputs the saturation determination value D30 set in step S507 to the saturation determination unit 113 (S508).

In a case where the frame to be processed is not the last frame in step S510 (S510: No), the processing unit 10 causes the procedure to proceed to the next frame (S512) and performs the processing in step S503 and the subsequent steps.

The operation of the saturation determination unit 113 according to the first example of the second embodiment is the same as the process illustrated in FIG. 12, and description thereof is omitted in the first example of the second embodiment.

### [Operation]

A case where the spectrum SP drawn in step S502 illustrated in FIG. 25 is the spectrum SP1 as illustrated in FIG. 13 will be described below.

In the example illustrated in FIG. 13, the maximum signal intensity of the spectrum SP1 is greater than or equal to the first threshold TH1 (“20000” (ADU) in the example illustrated in FIG. 13). Therefore, the saturation determination value setting unit 112 determines “Yes” in step S503 illustrated in FIG. 25. Subsequently, in step S504 illustrated in FIG. 25, the saturation determination value setting unit 112 calculates an absolute value DIF (see FIG. 26) of a second derivative of the spectrum SP for the frame to be processed.

FIG. 26 is a diagram illustrating the spectrum SP1 illustrated in FIG. 13 and the absolute value DIF of the second derivative for the spectrum SP1.

The spectrum SP1 indicated by a broken line in FIG. 26 is the same as the spectrum SP1 illustrated in FIG. 13.

In the example illustrated in FIG. 26, the maximum value (the maximum absolute value of the second derivative) of the absolute value DIF of the second derivative is less than the second threshold TH2. Therefore, the saturation determination value setting unit 112 determines “No” in step S505 illustrated in FIG. 25. That is, the saturation determination value setting unit 112 determines that saturation has not occurred in the frame to be processed.

Then, the saturation determination value setting unit 112 determines whether the frame to be processed is the last frame (S510). In a case where the frame to be processed is the last frame (S510: Yes), the saturation determination value setting unit 112 records “65535” (ADU) (S511). In a case where the frame to be processed is not the last frame (S510: No), the processing unit 10 causes the procedure to proceed to the next frame (S512).

In addition, a case where the spectrum SP drawn in step S502 illustrated in FIG. 25 is the spectrum SP3 as illustrated in FIG. 15 will be described below. In the spectrum SP3 illustrated in FIG. 15, the maximum signal intensity is greater than or equal to the first threshold TH1 (“20000” (ADU)). Therefore, the saturation determination value setting unit 112 determines “Yes” in step S503 illustrated in FIG. 25.

FIG. 27 is a diagram illustrating the spectrum SP3 illustrated in FIG. 15 and an absolute value DIF of a derivative for the spectrum SP3.

In the example illustrated in FIG. 27, the maximum value (the maximum absolute value of the second derivative) of the absolute value DIF of the second derivative for the spectrum SP3 is greater than or equal to the second threshold TH2. Therefore, the saturation determination value setting unit 112 determines “Yes” in step S505 illustrated in FIG. 25. That is, the saturation determination value setting unit 112 determines that Saturation has occurred in the frame to be processed. Then, the saturation determination value setting unit 112 records the lowest signal intensity among portions having signal intensities that are substantially constant in step S506 illustrated in FIG. 25. In the example illustrated in FIG. 26, since the portions having the signal intensities that are substantially constant are only a top portion of the spectrum SP3, the saturation determination value setting unit 112 records a signal intensity (about “48000” (ADU) in the example illustrated in FIG. 27) of the top portion of the spectrum SP3. Then, the saturation determination value setting unit 112 sets the value recorded in step S506 as the saturation determination value D30 (S507 illustrated in FIG. 25). Then, the saturation determination value setting unit 112 outputs the set saturation determination value D30 to the saturation determination unit 113 (S508 illustrated in FIG. 25).

A spectrum SP in a frame in which saturation has not occurred has a gradual change in slope as in the spectrum SP1 illustrated in FIG. 13. In this case, the absolute value DIF of the second derivative is generally small as in the example illustrated in FIG. 26.

Meanwhile, a spectrum SP in a frame in which saturation has occurred has a steep change in slope as in the spectrum SP3 illustrated in FIG. 15. In this case, the absolute value DIF of the second derivative is a large value in a region where the slope changes steeply as in the example illustrated in FIG. 26. Therefore, by comparing the absolute value DIF of the second derivative with the second threshold TH2, whether saturation has occurred in the frame to be processed can be determined.

### [Effects]

In the first example of the second embodiment, whether saturation has occurred is determined based on a change in slope in the spectrum SP. In Patent Literature 1, it is determined that saturation has occurred in a case where the signal intensity is greater than or equal to the signal intensity of “65535” (ADU) based on the saturation electrical charge amount of the summing gate 215. However, in this method, it is not possible to determine whether saturation has occurred in a case where such a spectrum SP as illustrated in FIG. 15 is obtained. In the first example of the second embodiment, it is determined whether the maximum absolute value of the second derivative of the spectrum SP is greater than the second threshold TH2 (S505 illustrated in FIG. 25). Therefore, even when such a spectrum SP3 as illustrated in FIG. 15 is obtained, it is possible to determine whether saturation has occurred, and set the signal intensity (saturation determination value D30) in a case where the saturation has occurred (S507).

As described above, according to the first example of the second embodiment, it is determined whether saturation has occurred, based on a change in slope in the spectrum SP, instead of determining whether the shape of the spectrum SP deviates from the shape of the Gaussian distribution as in the first embodiment. Therefore, according to the first example of the second embodiment, it is possible to reduce the calculation amount, in addition to the effects obtained in the first example of the first embodiment.

### Second Example of Second Embodiment

### [Configuration of Processing Unit 10]

A system configuration according to a second example of the second embodiment is the same as the configuration illustrated in FIG. 21, except that the saturation determination unit 113 determines whether saturation has occurred, based on a change in slope in a spectrum SP. Therefore, in the second example of the second embodiment, illustration of the configuration of the processing unit 10 is omitted.

### [Flowchart]

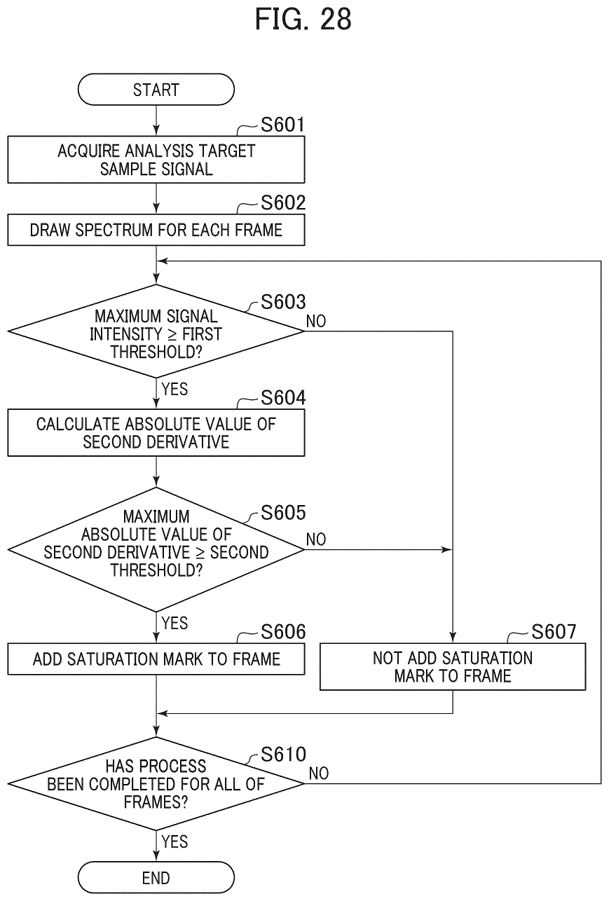

Next, a process procedure of an electrophoresis data processing method according to the second example of the second embodiment will be described with reference to FIG. 28.

FIG. 28 is a flowchart illustrating a procedure of a saturation determination process according to the second example of the second embodiment. Refer to FIG. 21 as appropriate.

First, the spectrum generation unit 111 acquires the analysis target sample signal D11 from the measurement unit 20 (S601). Step S601 corresponds to the signal acquisition step.

Next, in all frames, the spectrum generation unit 111 draws (generates) a spectrum SP (see FIG. 13) of the analysis target sample signal D11 for each of the frames (S602). Step S602 corresponds to the spectrum generation step.

Subsequently, the saturation determination unit 113 selects one of the frames. Then, the saturation determination unit 113 determines whether the maximum signal intensity of the spectrum SP drawn in step S602 is greater than or equal to the first threshold TH1 (see FIG. 13) for the selected frame (S603). The first threshold TH1 is the same as the first threshold TH1 used in the first example of the first embodiment.

In a case where the maximum signal intensity of the spectrum SP is greater than or equal to the first threshold TH1 in step S603 (S603: Yes), the saturation determination unit 113 calculates an absolute value DIF (see FIG. 26) of a second derivative (S604). The processing in step S604 is performed on the frame to be processed.

Subsequently, the saturation determination unit 113 determines whether the maximum value (the maximum absolute value of the second derivative) of the second derivative calculated in step S604 is greater than or equal to the second threshold TH2 (see FIG. 26) (S605). The second threshold TH2 is the same as the second threshold TH2 used in the first example of the second embodiment. Step S605 corresponds to the saturation determination step.

In a case where the maximum absolute value of the second derivative is greater than or equal to the second threshold TH2 (S605: Yes), the saturation determination unit 113 adds the saturation mark to the frame to be processed (S606).

In a case where the maximum absolute value of the second derivative is less than the second threshold TH2 (S605: No), the saturation determination unit 113 does not add the saturation mark to the frame to be processed (S607). That is, in step S607, the saturation determination unit 113 does not perform any processing.

In a case where the maximum signal intensity of the spectrum SP is less than the first threshold TH1 in step S603 (S603: No), the saturation determination unit 113 does not add the saturation mark to the frame to be processed (S607).

After the processing in step S606 or S607 is performed, the saturation determination unit 113 determines whether the process has been completed for all of the frames (S610).

In a case where the process has not been completed for all of the frames (S610: No), the processing unit 10 performs the processing in step S603 and the subsequent steps.

In a case where process has been completed for all of the frames (S610: Yes), the saturation determination unit 113 ends the saturation determination process.

### [Operation]

A case where the spectrum SP drawn in step S602 illustrated in FIG. 28 is the spectrum SP1 as illustrated in FIG. 13 will be described below. In the spectrum SP1 illustrated in FIG. 13, the maximum signal intensity is greater than or equal to the first threshold TH1 (“20000” (ADU) in the example illustrated in FIG. 13). Therefore, the saturation determination unit 113 determines “Yes” in step S603 illustrated in FIG. 28. In step S604 illustrated in FIG. 28, the saturation determination unit 113 calculates an absolute value DIF of a second derivative of the spectrum SP of the frame to be processed.

FIG. 26 is a diagram illustrating the spectrum SP1 illustrated in FIG. 13 and the absolute value DIF of the second derivative of the spectrum SP1. In FIG. 26, the spectrum SP1 indicated by a broken line is the same as the spectrum SP1 illustrated in FIG. 13.

In the example illustrated in FIG. 26, the maximum value (the maximum absolute value of the second derivative) of the absolute value DIF of the second derivative is less than the second threshold TH2. Therefore, the saturation determination unit 113 determines “No” in step S605 illustrated in FIG. 28. That is, the saturation determination unit 113 determines that saturation has not occurred in the frame to be processed. Accordingly, the saturation determination unit 113 does not add the saturation mark to the frame to be processed (S607 illustrated in FIG. 28).

Next, a case where the spectrum SP drawn in step S602 illustrated in FIG. 28 is the spectrum SP3 as illustrated in FIG. 15 will be described below.

In the spectrum SP3 illustrated in FIG. 15, the maximum signal intensity is greater than or equal to the first threshold TH1 (“20000” (ADU) in the example illustrated in FIG. 15). Therefore, the saturation determination unit 113 determines “Yes” in step S603 illustrated in FIG. 28 and causes the procedure to proceed to S604.

FIG. 27 is a diagram illustrating the spectrum SP3 illustrated in FIG. 15 and an absolute value DIF of a second derivative of the spectrum SP3 for a bin B.

In the example illustrated in FIG. 27, the maximum value (the maximum absolute value of the second derivative) of the absolute value DIF of the second derivative is greater than or equal to the second threshold TH2. Therefore, the saturation determination unit 113 determines “Yes” in step S605 illustrated in FIG. 28. That is, the saturation determination unit 113 determines that saturation has occurred in the frame to be processed, and adds the saturation mark to the frame to be processed (S606 illustrated in FIG. 28).

### [Effects]

In the second example of the second embodiment, as in the first example of the second embodiment, whether saturation has been occurred is determined based on a change (the absolute value DIF (see FIG. 26) of the second derivative) in slope in the spectrum SP (S605 illustrated in FIG. 28). Therefore, according to the second example of the second embodiment, as in the first embodiment, it is possible to add the saturation mark to a frame in which saturation has occurred (S606 illustrated in FIG. 28) regardless of a difference between saturation electrical charge amounts of measurement units 20. In addition, according to the second example of the second embodiment, as in the first embodiment, even if the CCD image sensor 210 has a small saturation electrical charge amount and is used, it is possible to add the saturation mark (S606 illustrated in FIG. 28).

According to the second example of the second embodiment, in addition to the effects obtained in the first example of the second embodiment, it is possible to determine whether saturation has occurred while the saturation determination value setting unit 112 according to the first example of the second embodiment is not provided.

### Third Example of Second Embodiment

### [Processing Unit 10]

In a third example of the second embodiment, a saturation reference sample D40 is used instead of using the analysis target sample D10 in a case where the saturation determination value D30 is set by the saturation determination value setting unit 112 according to the first example of the second embodiment.

A system configuration according to the third example of the second embodiment is the same as that in FIG. 23, except that the saturation determination value setting unit 112 determines whether saturation has occurred, based on a change in slope in a spectrum SP. Therefore, in the third example of the second embodiment, illustration of the processing unit 10 is omitted.

### [Flowchart ]

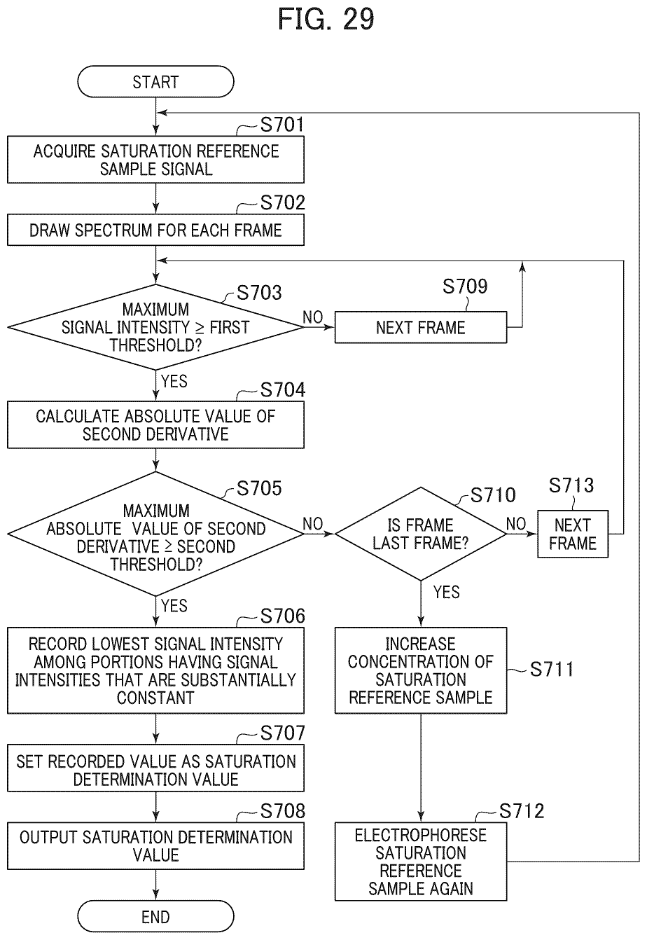

Next, a process procedure of an electrophoresis data processing method according to the third example of the second embodiment will be described with reference to FIG. 29.

FIG. 29 is a flowchart illustrating a procedure of a process of setting a saturation determination value according to the third example of the second embodiment.

Refer to FIG. 23 as appropriate.

First, the spectrum generation unit 111 acquires a saturation reference sample signal D41 from the measurement unit 20 (S701). Step S701 corresponds to the signal acquisition step.

Next, the spectrum generation unit 111 draws (generates) a spectrum SP based on the acquired saturation reference sample signal D41 for each of frames (S702). Step S702 corresponds to the spectrum generation step.

Subsequently, the saturation determination value setting unit 112 selects one frame among the frames. Then, the saturation determination value setting unit 112 determines whether the maximum signal intensity of the spectrum SP drawn in step S702 is greater than or equal to the first threshold TH1 (see FIG. 13) for the selected frame (S703). The first threshold TH1 is the same as the first threshold TH1 used in the first example of the first embodiment.

In a case where the maximum signal intensity of the spectrum SP is less than the first threshold TH1 (S703: No), the processing unit 10 causes the procedure to proceed to the next frame (S709) and performs the processing in step S703 and the subsequent steps.

In a case where the maximum signal intensity of the spectrum SP is greater than or equal to the first threshold TH1 (S703: Yes), the saturation determination value setting unit 112 calculates an absolute value DIF (see FIG. 26) of a second derivative for the spectrum SP (S704). The processing in step S704 is performed on the frame to be processed.

Then, the saturation determination value setting unit 112 determines whether the maximum value DIF (the maximum absolute value of the second derivative) of the second derivative calculated in step S704 is greater than or equal to the second threshold TH2 (see FIG. 26) (S705). The second threshold TH2 is the same as the second threshold TH2 used in the first example of the second embodiment. Step S705 corresponds to the saturation determination step.

In a case where the maximum absolute value of the second derivative is greater than or equal to the second threshold TH2 (S705: Yes), the saturation determination value setting unit 112 determines that saturation has occurred in the measurement unit 20, and performs processing in step S706. In step S706, the saturation determination value setting unit 112 records the lowest signal intensity among portions having signal intensities that are substantially constant in the spectrum SP.

Subsequently, the saturation determination value setting unit 112 sets the value of the recorded signal intensity as the saturation determination value D30 (S707) and outputs the set saturation determination value D30 to the saturation determination unit 113 (S708).

In a case where the maximum absolute value of the second derivative is less than the second threshold TH2 (S705: No), the saturation determination value setting unit 112 determines whether the frame to be processed is the last frame (S710).

In a case where the frame to be processed is the last frame (S710: Yes), the user increases (thickens) the concentration of the saturation reference sample D40 (S711). Thereafter, the user performs electrophoresis again on the saturation reference sample D40 whose concentration has been changed (S712). The reason why the processing in step S711 and S712 is performed is the same as the reason for steps S411 and S412 illustrated in FIG. 24.

In a case where the frame to be processed is not the last frame (S710: No), the processing unit 10 causes the procedure to proceed to the next frame (S713) and performs the processing in step S703 and the subsequent steps.

After the electrophoresis is performed again in step S712, the processing unit 10 performs the processing in step S701 and the subsequent steps.

A process that is performed by the saturation determination unit 113 in the third example of the second embodiment is the same as the process illustrated in FIG. 12, and therefore description of the process by the saturation determination unit 113 is omitted in the third example of the second embodiment. However, in the third example of the second embodiment, after the electrophoresis of the analysis target sample D10 is performed again, the process illustrated in FIG. 12 is performed.

### [Operation]

A case where the spectrum SP drawn in step S702 illustrated in FIG. 29 is the spectrum SP2 as illustrated in FIG. 13 will be described below. In the spectrum SP2 illustrated in FIG. 13, the maximum signal intensity is greater than or equal to the first threshold TH1 (“20000” (ADU) in the example illustrated in FIG. 13). Therefore, the saturation determination value setting unit 112 determines “Yes” in step S703 illustrated in FIG. 29. Then, the saturation determination value setting unit 112 calculates an absolute value DIF (see FIG. 26) of the second derivative of the spectrum SP2 of the frame to be processed for a bin B.

FIG. 26 is a diagram illustrating the spectrum SP1 illustrated in FIG. 13 and the absolute value DIF of the second derivative of the spectrum SP1.

In the example illustrated in FIG. 26, the maximum value (the maximum absolute value of the second derivative) of the absolute value DIF of the second derivative for the bin B is less than the second threshold TH2. Therefore, the saturation determination value setting unit 112 determines “No” in step S705 illustrated in FIG. 29. That is, the saturation determination value setting unit 112 determines that saturation has not occurred in the frame to be processed. Then, in step S710 illustrated in FIG. 29, the saturation determination value setting unit 112 determines whether the frame to be processed is the last frame. In a case where the frame to be processed is the last frame (S710 illustrated in FIG. 29: Yes), the user changes the concentration of the saturation reference sample D40 (S711 illustrated in FIG. 29) in a high level and performs electrophoresis again on the saturation reference sample D40 whose concentration has been changed (S712). In a case where the frame to be processed is not the last frame (S710 illustrated in FIG. 29: No), the processing unit 10 causes the procedure to proceed to the next frame (S713 illustrated in FIG. 29).

In addition, a case where the spectrum SP drawn in step S702 illustrated in FIG. 29 is the spectrum SP3 as illustrated in FIG. 15 will be described below. In the spectrum SP3 illustrated in FIG. 15, the maximum signal intensity is greater than or equal to the first threshold TH1 (about “20000” (ADU) in the example illustrated in FIG. 15). Therefore, the saturation determination value setting unit 112 determines “Yes” in step S703 illustrated in FIG. 29. Then, in step S704 illustrated in FIG. 29, the saturation determination value setting unit 112 calculates an absolute value DIF (see FIG. 26) of a second derivative for the spectrum SP3 to be processed.

FIG. 27 is a diagram illustrating the spectrum SP3 illustrated in FIG. 15 and the absolute value DIF of the second derivative for the spectrum SP3.

In the example illustrated in FIG. 27, the maximum absolute value of the second derivative is greater than or equal to the second threshold TH2. Therefore, the saturation determination value setting unit 112 determines “Yes” in step S705 illustrated in FIG. 29. That is, the saturation determination value setting unit 112 determines that saturation has occurred in a frame to be processed. Then, the saturation determination value setting unit 112 records the lowest signal intensity among portions having signal intensities that are substantially constant in step S706 illustrated in FIG. 29. Since the portions having the signal intensities that are substantially constant are only the top portion of the spectrum SP in the example illustrated in FIG. 27, the saturation determination value setting unit 112 records a signal intensity in the top portion of the spectrum SP in step S706 illustrated in FIG. 29. In the example illustrated in FIG. 27, “48000” (ADU) is stored in step S706 illustrated in FIG. 29. Then, the saturation determination value setting unit 112 sets the recorded value as the saturation determination value D30 (S707 illustrated in FIG. 29). Then, the saturation determination value setting unit 112 outputs the set Saturation determination value D30 to the saturation determination unit 113 (S708 illustrated in FIG. 29).

### [Effects]

In the third example of the second embodiment, as in the first example of the second embodiment, it is determined whether saturation has occurred, based on a change (the absolute value DIF (see FIG. 26) of the second derivative) in slope in the spectrum SP (S705 illustrated in FIG. 29). Therefore, as in the first embodiment, the processing unit 10 can determine whether saturation has occurred, regardless of a difference between saturation electrical charge amounts of measurement units 20. As described above, the saturation determination value setting unit 112 can set the signal intensity (saturation determination value D30) in a case where saturation has occurred (S707 illustrated in FIG. 29). In addition, even if the CCD image sensor 210 has a small saturation electrical charge amount and is used, it is possible to set the signal intensity (saturation determination value D30) in a case where saturation has occurred (S707).

According to the third example of the second embodiment, as in the third example of the first embodiment, the setting of the saturation determination value D30 that is performed every time electrophoresis is performed in the first example of the second embodiment can be performed only by performing electrophoresis of the saturation reference sample D40 once.

### Third Embodiment

In the first embodiment, whether saturation has occurred is determined based on whether the shape of the spectrum SP (see FIG. 13) significantly deviates from the shape of the Gaussian distribution. In the second embodiment, whether saturation has occurred is determined based on a change (the absolute value DIF (see FIG. 26) of the second derivative) in slope in the shape of the spectrum SP. Meanwhile, in a third embodiment, whether saturation has occurred is determined based on the sum of squares of differences between the spectrum SP based on the analysis sample D10 and the spectrum SP of the matrix standard D20.

### First Example of Third Embodiment

### [System Configuration]

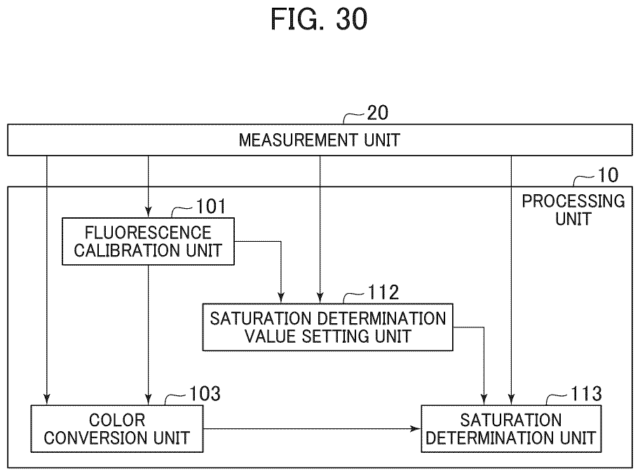

FIG. 30 is a diagram illustrating an outline of a configuration of an electrophoresis device 1 according to a first example of the third embodiment.

As illustrated in FIG. 30, the electrophoresis device 1 includes a measurement unit 20 and a processing unit 10.

In addition, the processing unit 10b mainly includes a fluorescence calibration unit 101, a color conversion unit 103, a saturation determination value setting unit 112, and a saturation determination unit 113.

Processing by the fluorescence calibration unit 101 and the color conversion unit 103 is the same as described above. The saturation determination unit 113 and a process that is performed by the saturation determination unit 113 will be described below.

In the first example of the third embodiment, the saturation determination value setting unit 112 has a function of a spectrum generation unit described in the claims.

### [Processing Unit 10]

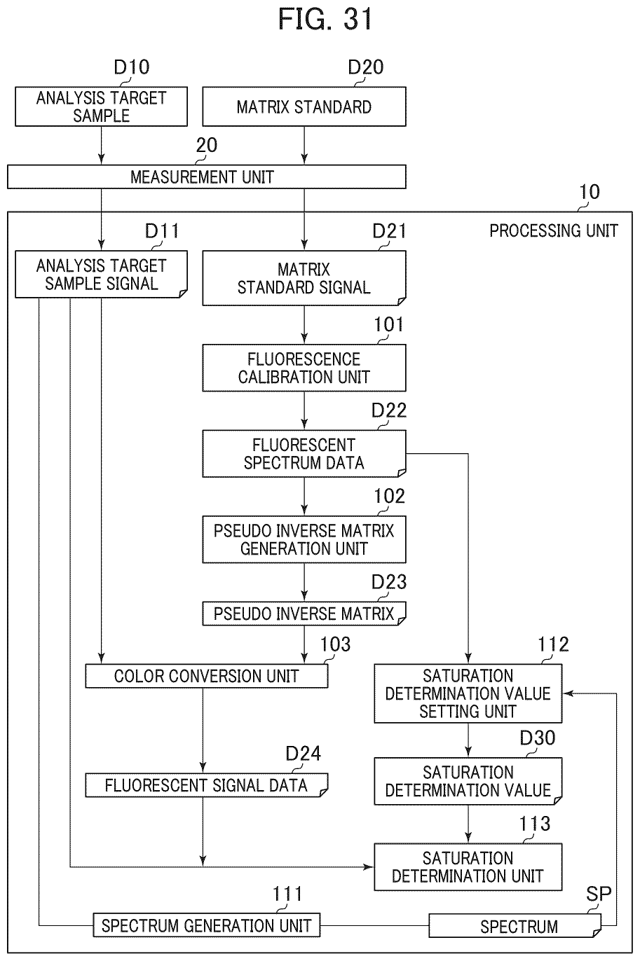

FIG. 31 is a diagram illustrating details of a configuration of the processing unit 10 according to the first example of the third embodiment.

As illustrated in FIG. 31, the measurement unit 20 outputs an analysis target sample signal D11 to the processing unit 10. In addition, the measurement unit 20 outputs a matrix standard signal D21 to the processing unit 10.

The fluorescence calibration unit 101 convers the matrix standard signal D21 output from the measurement unit 20 into fluorescent spectrum data D22 having a predetermined shape, and outputs the fluorescent spectrum data D22 to the pseudo inverse matrix generation unit 102 and the saturation determination value setting unit 112.

The pseudo inverse matrix generation unit 102 acquires the fluorescent spectrum data D22 output from the fluorescence calibration unit 101 and generates a pseudo inverse matrix D23 of the fluorescent spectrum data D22. The pseudo inverse matrix generation unit 102 outputs the generated pseudo inverse matrix D23 to the color conversion unit 103.

The color conversion unit 103 acquires the analysis target sample signal D11 from the measurement unit 20 and acquires the pseudo inverse matrix D23 from the pseudo inverse matrix generation unit 102. Then, the color conversion unit 103 multiplies the pseudo inverse matrix D23 by the analysis target sample signal D11. By performing this, the color conversion unit 103 generates fluorescent signal data D24. Subsequently, the color conversion unit 103 outputs the generated fluorescent signal data D24 to the Saturation determination unit 113.

The spectrum generation unit 111 acquires the analysis target sample signal D11 and outputs the spectrum SP1 of the analysis target sample signal D11.

The saturation determination value setting unit 112 acquires the normalized analysis target sample signal D11 (normalized analysis target sample signal) from a normalization unit (not illustrated). In addition, the saturation determination value setting unit 112 acquires the fluorescent spectrum data D22 from the fluorescence calibration unit 101. Then, the saturation determination value setting unit 112 sets the saturation determination value D30 based on the normalized analysis target sample signal and the fluorescent spectrum data D22. The saturation determination value setting unit 112 outputs the set saturation determination value D30 to the saturation determination unit 113.

### [Flowchart ]

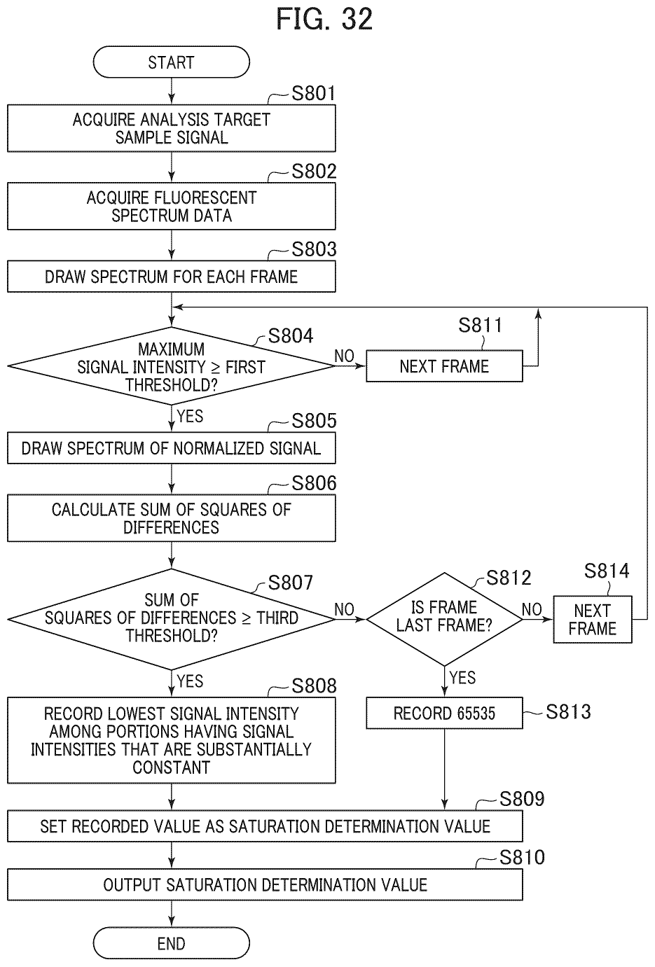

Next, a process procedure of an electrophoresis data processing method according to the first example of the third embodiment will be described below with reference to FIG. 32.

FIG. 32 is a flowchart illustrating a procedure of a process of setting the saturation determination value according to the first example of the third embodiment.

Refer to FIG. 31 as appropriate.

First, the spectrum generation unit 111 acquires the analysis target sample signal D11 (S801). Step S801 corresponds to the signal acquisition step.

Subsequently, the saturation determination value setting unit 112 acquires the fluorescent spectrum data D22 from the fluorescent calibration unit 101 (S802). It should be noted that the fluorescent spectrum data D22 is binned.

It should be noted that fluorescent spectrum data D22 is generated using the matrix standard signal D21 acquired by a binned bin B. In steps S801 and S802, the analysis target sample signal D11 and the fluorescent spectrum data D22 are acquired for all of frames.

Then, the spectrum generation unit 111 draws (generates) a spectrum SP based on the analysis target sample signal D11 for each of the frames (S803).

Subsequently, the saturation determination value setting unit 112 selects one frame among the frames. Then, the saturation determination value setting unit 112 determines whether the maximum signal intensity of the spectrum SP drawn in step S803 is greater than or equal to the first threshold TH1 for the selected frame (S804). The first threshold TH1 is the same as the first threshold TH1 used in the first embodiment.

In a case where the maximum signal intensity of the spectrum SP is less than the first threshold TH1 (S804: No), the processing unit 10 causes the procedure to proceed to the next frame (S811) and performs the processing in step S804 and the subsequent steps.

In a case where the maximum signal intensity of the spectrum SP is greater than or equal to the first threshold TH1 (S804: Yes), the saturation determination value setting unit 112 performs processing in step S805.

In step S805, the saturation determination value setting unit 112 generates a normalized analysis target sample signal having a normalized signal intensity by normalizing the analysis target sample signal D11 for the frame to be processed. In addition, a spectrum of the normalized analysis target sample signal is drawn. In step S805, the saturation determination value setting unit 112 normalizes the analysis target sample signal D11 such that the maximum signal intensity is “1” in each of the frames. The normalized analysis target sample signal D11 is referred to as a normalized analysis target sample signal. Step S805 corresponds to the spectrum generation step.

Subsequently, the saturation determination value setting unit 112 calculates a sum of squares of differences between the spectrum SP of the normalized analysis target sample signal generated in S805 and having the normalized signal intensity and the shape of the fluorescent spectrum data D22 that is the predetermined shape (S806). The sum of the squares of the differences is calculated in the following manner. First, the saturation determination value setting unit 112 calculates differences between two spectra SP for each bin B. Next, the saturation determination value setting unit 112 squares each of the values of the calculated differences. Thereafter, the saturation determination value setting unit 112 sums the values of the squared differences. The fluorescent spectrum data D22 is the spectrum SP for each fluorescent label in the matrix standard signal D21. In step S806, the saturation determination value setting unit 112 compares the shape of the fluorescent spectrum data D22 with the spectrum of the normalized signal intensity (normalized analysis target sample signal) obtained by normalizing the signal intensity.

The fluorescent spectrum data D22 includes spectra SP derived from a plurality of matrix standards D20. In step S806, any spectrum among the spectra SP derived from the matrix standards D20 may be used.

As described above, in step S806, the saturation determination value setting unit 112 calculates the sum of the squares of the differences between the spectrum SP of the normalized analysis target sample signal and the fluorescent spectrum data D22.

Then, the saturation determination value setting unit 112 determines whether the sum of the squares of the differences calculated in step S806 is greater than or equal to a third threshold (S807). As the third threshold, a value that satisfies both of the following (B1) and (B2) is set in advance. Step S807 corresponds to the saturation determination step.

(B1) The value is sufficiently less than the sum of squares of differences between the spectrum SP of the normalized analysis target sample signal in a case where saturation has occurred and the fluorescent spectrum data D22.

(B2) The value is sufficiently greater than the sum of squares of differences between the spectrum SP of the normalized analysis target sample signal in a case where saturation has not occurred and the fluorescent spectrum data D22.

In a case where the sum of the squares of the differences is greater than or equal to the third threshold (S807: Yes), the saturation determination value setting unit 112 determines that saturation has occurred in the measurement unit 20, and performs processing in step S808.

In step S808, the saturation determination value setting unit 112 records the lowest signal intensity among portions having signal intensities that are substantially constant in the normalized analysis target sample signal. Then, the saturation determination value setting unit 112 sets the value of the signal intensity recorded in step S808 as the Saturation determination value D30 (S809). Thereafter, the saturation determination value setting unit 112 outputs the set saturation determination value D30 to the saturation determination unit 113 (S810).

In a case where the sum of the squares of the differences is less than the third threshold in step S807 (S807: No), the saturation determination value setting unit 112 determines whether the frame to be processed is the last frame (S812). It should be noted that the frames are frames in the analysis target sample signal D11.

In a case where the frame to be processed is the last frame (S812: Yes), the saturation determination value setting unit 112 records “65535” (ADU) (S813). Then, the saturation determination value setting unit 112 sets the recorded value “65535” (ADU) as the saturation determination value D30 (S809).

In a case where the frame to be processed is not the last frame (S812: No), the processing unit 10 causes the procedure to proceed to the next frame (S814) and performs the processing in step S804 and the subsequent steps.

The operation of the saturation determination unit 113 according to the first example of the third embodiment is the same as that described with reference to FIG. 12, and illustration and description thereof are omitted.

### [Operation]

A case where the spectrum SP of the analysis target sample signal D11 drawn in S803 illustrated in FIG. 32 is the spectrum SP as illustrated in FIG. 13 will be described below.

In the spectrum SP1 illustrated in FIG. 13, the maximum signal intensity is greater than or equal to the first threshold TH1 (about “20000” (ADU) in the example illustrated in FIG. 13). Therefore, the saturation determination value setting unit 112 determines “Yes” in step S804 illustrated in FIG. 32. Then, in step S805 illustrated in FIG. 32, the saturation determination value setting unit 112 generates a normalized analysis target sample signal for the frame to be processed. Subsequently, the saturation determination value setting unit 112 calculates a sum of squares of differences between a spectrum SP of the generated normalized analysis target sample signal and the fluorescent spectrum data D22 (S806 illustrated in FIG. 32).

In the example illustrated in FIG. 13, the sum of the squares of the differences between the spectrum SP of the normalized analysis target sample signal and the fluorescent spectrum data D22 is less than the third threshold. The shape of the spectrum SP of the normalized analysis target sample signal and the shape of the spectrum SP of the analysis target sample signal D11 not normalized have the Same shape, except for the heights of the spectra SP. Therefore, the saturation determination value setting unit 112 determines “No” in step S807 illustrated in FIG. 32. That is, the saturation determination value setting unit 112 determines that saturation has not occurred. Thereafter, the saturation determination value setting unit 112 determines whether the frame is the last frame (S812 illustrated in FIG. 32). In a case where the frame is the last frame (S812 illustrated in FIG. 32: Yes), the saturation determination value setting unit 112 records “65535” (ADU) (S813 illustrated in FIG. 32). In a case where the frame is the not last frame (S812 illustrated in FIG. 32: No), the processing unit 10 causes the procedure to proceed to the next frame (S814 illustrated in FIG. 32).

In addition, a case where the spectrum SP drawn in step S803 illustrated in FIG. 32 is the spectrum SP3 as illustrated in FIG. 15 will be described below.

In the spectrum SP3 illustrated in FIG. 15, the maximum signal intensity is greater than or equal to the first threshold TH1 (“20000” (ADU) in the example illustrated in FIG. 15). Therefore, the saturation determination value setting unit 112 determines “Yes” in step S804 illustrated in FIG. 32. Then, in step S805 illustrated in FIG. 32, the saturation determination value setting unit 112 generates a normalized target sample signal by normalizing the analysis target sample signal D11 to be processed. Subsequently, the saturation determination value setting unit 112 calculates a sum of squares of differences between the generated normalized analysis target sample signal and the fluorescent spectrum data D22 (S806 illustrated in FIG. 32).

In the case illustrated in FIG. 15, the sum of the squares of the differences between the spectrum SP of the normalized analysis target sample signal and the fluorescent spectrum data D22 is greater than or equal to the third threshold. Therefore, the saturation determination value setting unit 112 determines “Yes” in step S807 illustrated in FIG. 32. That is, the saturation determination value setting unit 112 determines that saturation has occurred. Thereafter, in step S808 illustrated in FIG. 32, the saturation determination value setting unit 112 records the lowest signal intensity among portions having signal intensities that are substantially constant. In the example illustrated in FIG. 15, since the portions having the signal intensities that are substantially constant are only the top portion of the spectrum SP, the saturation determination value setting unit 112 records the signal intensity of the top portion of the spectrum SP in step S808 illustrated in FIG. 32. In the example illustrated in FIG. 15, “48000” (ADU) is recorded. Then, the saturation determination value setting unit 112 sets the recorded value as the saturation determination value D30 (S809 illustrated in FIG. 32). Thereafter, the saturation determination value setting unit 112 outputs the set saturation determination value D30 to the saturation determination unit 113 (S810 illustrated in FIG. 32).

The spectrum SP of the normalized analysis target sample signal in a frame in which saturation has not occurred almost matches the fluorescent spectrum data D22. Therefore, the sum of the squares of the differences between the spectrum of the normalized analysis target sample signal and the fluorescent spectrum data D22 is almost “0”.

On the other hand, in a frame in which saturation has occurred, the top portion of the spectrum SP has a flat shape as in the example illustrated in FIG. 15. In this case, the spectrum SP of the normalized analysis target sample signal has a shape significantly different from the fluorescent spectrum data D22. Therefore, the sum of the squares of the differences between the spectrum SP of the normalized analysis target sample signal and the fluorescent spectrum data D22 is a large value. Therefore, the saturation determination value setting unit 112 can determine whether saturation has occurred by comparing the sum of the squares of the differences between spectrum SP of the normalized analysis target sample signal and the fluorescent spectrum data D22 with the third threshold.

### [Effects]

In the first example of the third embodiment, whether saturation has occurred is determined based on the sum of the squares of the differences between spectrum SP of the normalized analysis target sample signal and the fluorescent spectrum data D22. As in Patent Literature 1, in a method in which it is determined that saturation has occurred in a case the signal intensity is greater than or equal to “65535” (ADU), it cannot be determined whether saturation has occurred for such a spectrum SP3 as illustrated in FIG. 15. On the other hand, in the first example of the third embodiment, it is determined whether the sum of the squares of the differences between the spectrum SP of the normalized analysis target sample signal and the fluorescent spectrum data D22 is greater than the third threshold (S807 illustrated in FIG. 32). As described above, even for such a spectrum SP3 as illustrated in FIG. 15, it is possible to determine whether saturation has occurred. In addition, it is possible to set the signal intensity (saturation determination value D30) in a case where saturation has occurred (S809).

According to the first example of the third embodiment, whether saturation has occurred is determined based on the differences between the shape of the spectrum SP based on the analysis target sample signal D11 and the shape of the spectrum SP based on the matrix standard signal D21. Therefore, in the first example of the third embodiment, in addition to the effects obtained in the first example of the first embodiment, it is possible to accurately determine whether saturation has occurred.

### Second Example of Third Embodiment

### [System Configuration]

In a second example of the third embodiment, the saturation determination value setting unit 112 sets the saturation determination value D30. In addition, the saturation determination unit 113 determines whether saturation has occurred, based on whether the analysis target sample signal D11 exceeds the saturation determination value D30. On the other hand, in the second example of the third embodiment, instead of the saturation determination value setting unit 112 setting the saturation determination value D30, the saturation determination unit 113 determines whether saturation has occurred in each of the frames, based on the shape of a spectrum SP.

### [Processing Unit 10]

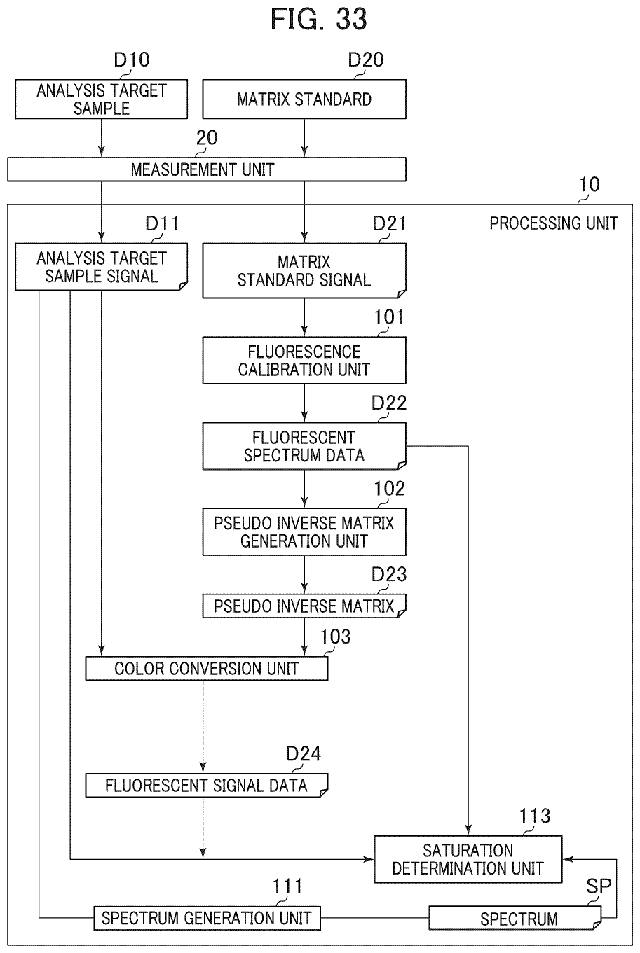

FIG. 33 is a diagram illustrating details of a configuration of a processing unit 10 according to the second example of the third embodiment.

Features illustrated in FIG. 33 and different from those in FIG. 31 will be described.

FIG. 33 is different from FIG. 31 in that illustration of the saturation determination value setting unit 112 illustrated in FIG. 31 is omitted. The other features illustrated in FIG. 33 are the same as those illustrated in FIG. 31, and description thereof is omitted.

In the second example of the third embodiment, the Saturation determination unit 113 includes the function of the spectrum generation unit described in the claims.

### [Flowchart]

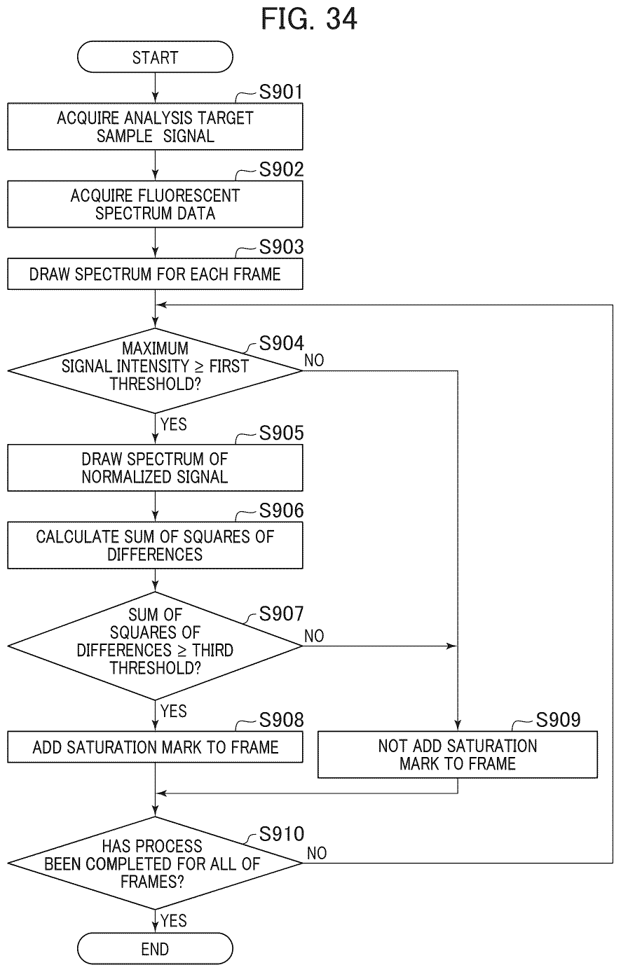

Next, a process procedure of an electrophoresis data processing method according to the second example of the third embodiment will be described with reference to FIG. 34.

FIG. 34 is a flowchart illustrating a procedure of saturation determination by the saturation determination unit 113 according to the second example of the third embodiment. Refer to FIG. 33 as appropriate.

First, the saturation determination unit 113 acquires an analysis target sample signal D11 from the measurement unit 20 (S901). Step S901 corresponds to the signal acquisition step.

Next, the spectrum generation unit 111 acquires the fluorescent spectrum data D22 from the fluorescence calibration unit 101 (S902).

Next, in all frames, the spectrum generation unit 111 draws a spectrum SP of the analysis target sample signal D11 for each of the frames (S903). In the spectrum SP, the horizontal axis indicates a number of a bin B, and the vertical axis indicates a signal intensity of the bin B, as described above.

Subsequently, the saturation determination unit 113 selects one of the frames. Then, the saturation determination unit 113 determines whether the maximum signal intensity of the spectrum SP drawn in step S903 is greater than or equal to the first threshold TH1 (see FIG. 13) for the selected frame (S904). The first threshold TH1 is the same as the first threshold TH1 used in the first example of the first embodiment.

In a case where the maximum signal intensity of the spectrum SP is greater than or equal to the first threshold TH1 in step S904 (S904: Yes), the saturation determination unit 113 performs processing in step S905.

In step S905, the saturation determination unit 113 generates a normalized analysis target sample signal for the frame to be processed. In addition, the saturation determination unit 113 draws a spectrum SP of the normalized analysis target sample signal. The normalized analysis target sample signal is generated using the same method as described in the first example of the third embodiment. Step S905 corresponds to the spectrum generation step.

Subsequently, the saturation determination unit 113 calculates a sum of squares of differences between the spectrum SP of the normalized analysis target sample signal generated in step S905 and the fluorescent spectrum data D22 (S906).

Subsequently, the saturation determination unit 113 determines whether the sum of the squares of the differences calculated in step S906 is greater than or equal to the third threshold (S907). The third threshold is the same as the third threshold used in the first example of the third embodiment. Step S907 corresponds to the saturation determination step.

In a case where the sum of the squares of the differences is greater than or equal to the third threshold (S907: Yes), the saturation determination unit 113 adds a saturation mark to the frame to be processed (S908).

In a case where the sum of the squares of the differences is less than the third threshold (S907: No), the saturation determination unit 113 does not add the saturation mark to the frame to be processed (S909). That is, in step S909, the processing unit 10 does not perform any processing.

In addition, in a case where the maximum signal intensity of the spectrum SP is less than the first threshold TH1 in step S904 (S904: No), the saturation determination unit 113 does not add the saturation mark to the frame to be processed (S909).

After the processing in step S908 or S909 is performed, the saturation determination unit 113 determines whether the process has been completed for all of the frames (S910).

In a case where the process has not been completed for all of the frames (S910: No), the processing unit 10 performs the processing in step S904 and the subsequent steps.

In a case where the process has been completed for all of the frames (S910: Yes), the saturation determination unit 113 ends the saturation determination process.

### [Operation]

In the second example of the third embodiment, as in the first example of the third embodiment, the saturation determination unit 1132 determines whether saturation has occurred, based on the sum of the squares of the differences between the normalized analysis target sample signal and the fluorescent spectrum data D22 (S907). Therefore, it is possible to add the saturation mark to a frame in which saturation has occurred, regardless of a difference between saturation electrical charge amounts of devices. The other operation is the same as that in the second example of the first embodiment.

### [Effects]

According to the second example of the third embodiment, in addition to the effects obtained in the first example of the third embodiment, it is possible to determine whether saturation has occurred while the saturation determination value setting unit 112 according to the first example of the third embodiment is not provided.

### Third Example of Third Embodiment

In a third example of the third embodiment, the saturation reference sample signal D41 is used instead of using the analysis target sample signal D11 in order for the saturation determination value setting unit 112 to set the saturation determination value D30 in the first example of the third embodiment.

### [Processing Unit 10]

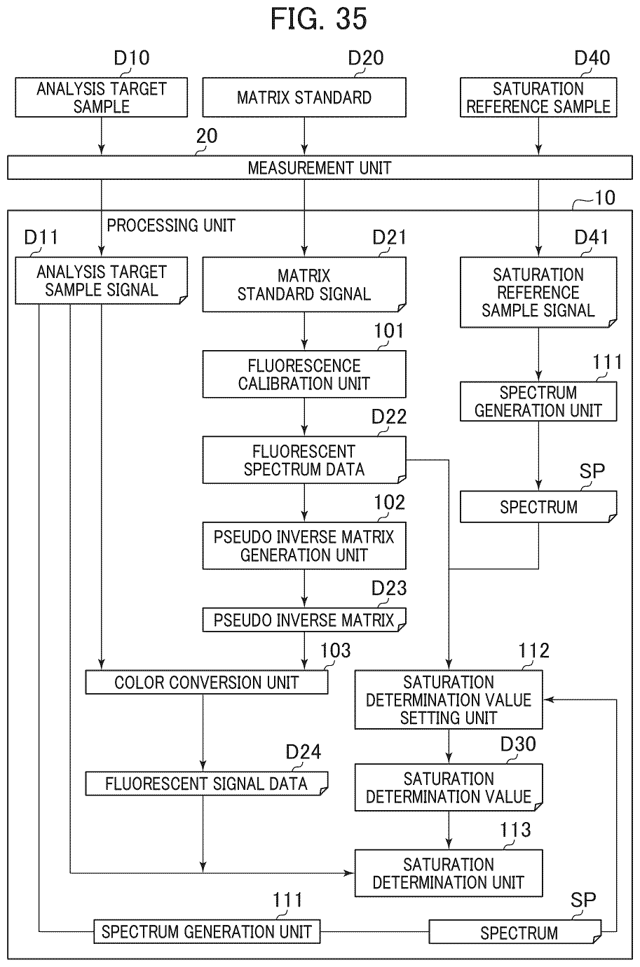

FIG. 35 is a diagram illustrating a configuration of a processing unit 10 according to the third example of the third embodiment.

Features illustrated in FIG. 35 and different from those in FIG. 31 will be described.

In the processing unit 10 illustrated in FIG. 35, the spectrum generation unit 111 generates a spectrum SP of the saturation reference sample signal D41 obtained from the saturation reference sample D40. Then, the saturation determination value setting unit 112 calculates a sum of squares of differences between the fluorescent spectrum data D22 and a normalized saturation reference sample signal obtained by normalizing the saturation reference sample signal D41. Then, the saturation determination value setting unit sets the saturation determination value D30 in a case where the calculated sum of the squares of the differences exceeds the third threshold that is the predetermined threshold. Other features are the same as those described with reference to FIG. 31. In addition, in the processing unit 10 illustrated in FIG. 35, data regarding the analysis target sample signal D11 is not input to the saturation determination value setting unit 112. In the third example of the third embodiment, the saturation determination value setting unit 112 has the function of the spectrum generation unit described in the claims.

### [Flowchart ]

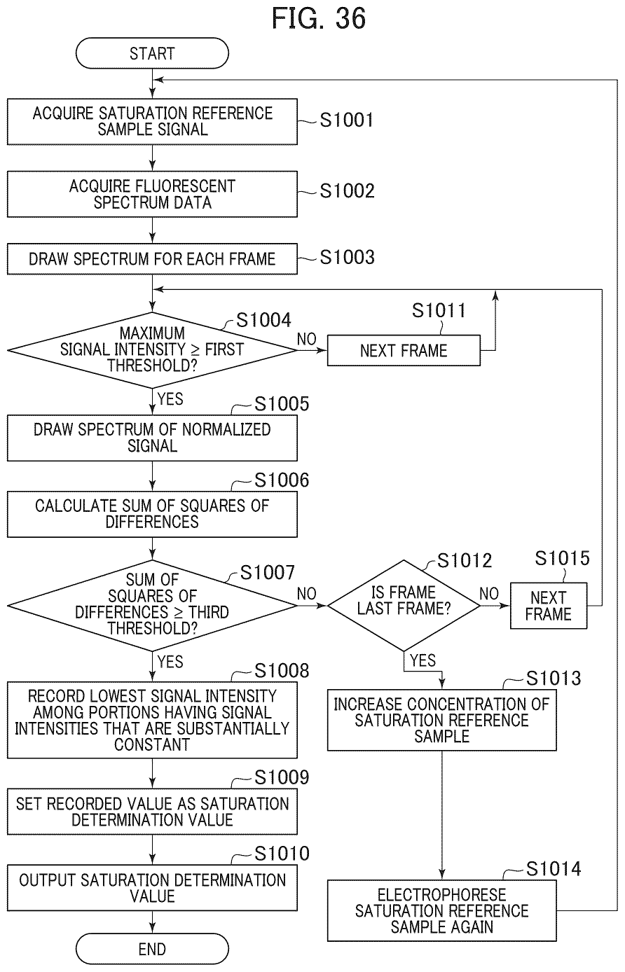

Next, a process procedure of an electrophoresis data processing method according to the third example of the third embodiment will be described with reference to FIG. 36.

FIG. 36 is a flowchart illustrating a procedure of a process of setting the saturation determination value according to the third example of the third embodiment.

Refer to FIG. 35 as appropriate.

First, the spectrum generation unit 111 acquires the saturation reference sample signal D41 from the measurement unit 20 (S1001). Step S1001 corresponds to the signal acquisition step.

Next, the saturation determination value setting unit 112 acquires the fluorescent spectrum data D22 from the fluorescence calibration unit 101 (S1002).

Subsequently, the spectrum generation unit 111 draws a spectrum SP of the saturation reference sample signal D41 for each of frames of the saturation reference sample signal D41 (S1003). In the spectrum SP, the axis indicates a number of a bin B and the vertical axis indicates the signal intensity of the bin B, as described above.

Then, the saturation determination value setting unit 112 selects one of the frames. Then, the saturation determination value setting unit 112 determines whether the maximum signal intensity in the spectrum SP of the saturation reference sample signal D41 drawn in step S1003 is greater than or equal to the first threshold TH1 (see FIG. 13) for the selected frame (S1004). The first threshold TH1 is the same as the first threshold TH1 used in the first example of the first embodiment.

In a case where the maximum signal intensity of the spectrum SP is less than the first threshold TH1 (S1004: No), the processing unit 10 causes the procedure to proceed to the next frame (S1011) and performs the processing in step S1004 and the subsequent steps.

In a case where the maximum signal intensity of the spectrum SP is greater than or equal to the first threshold TH1 (S1004: Yes), the saturation determination value setting unit 112 performs processing in step S1005.

In step S1005, the saturation determination value setting unit 112 generates a normalized saturation reference sample signal having a normalized signal intensity by normalizing the saturation reference sample signal D41 for the frame to be processed. In addition, the saturation determination value setting unit 112 draws a spectrum SP of the normalized saturation reference sample signal. Step S1005 corresponds to the spectrum generation step.

Subsequently, the saturation determination value setting unit 112 calculates a sum of squares of differences between the normalized saturation reference sample signal generated in step S1005 and the fluorescent spectrum data D22 (S1006).

Subsequently, the saturation determination value setting unit 112 determines whether the sum of the squares of the differences calculated in S1006 is greater than or equal to the third threshold (S1007). The third threshold is the same as the third threshold used in the first example of the third embodiment. In this manner, the saturation determination value setting unit 112 compares the shape of the fluorescent spectrum data D22 with the spectrum of the normalized signal intensity (normalized saturation reference sample signal) obtained by normalizing the signal intensity. Step S1007 corresponds to the saturation determination step.

In a case where the sum of the squares of the differences is greater than or equal to the third threshold (S1007: Yes), the saturation determination value setting unit 112 determines that saturation has occurred in the measurement unit 20, and performs processing in step S1008. In step S1008, the saturation determination value setting unit 112 records a signal intensity among portions having signal intensities that are substantially constant in the spectrum SP of the normalized saturation reference sample signal.

Subsequently, the saturation determination value setting unit 112 sets the value of the signal intensity recorded in step S1008 as the saturation determination value D30 (S1009) and outputs the saturation determination value D30 to the saturation determination unit 13 (S1010).

In addition, in a case where the sum of the squares of the differences is less than the third threshold in step S1007 (S1007: No), the saturation determination value setting unit 112 determines whether the frame to be processed is the last frame (S1012).

In a case where the frame to be processed is the last frame (S1012: Yes), the user increases (thickens) the concentration of the saturation reference sample D40 (S1013). Thereafter, the user performs electrophoresis again on the saturation reference sample D40 whose concentration has been changed (S1014). The reason why the processing in steps S1013 and S1014 is performed is the same as the reason for steps S411 and S412 illustrated in FIG. 24.

In a case where the frame to be processed is not the last frame (S1012: No), the processing unit 10 causes the procedure to proceed to the next frame (S1015) and performs the processing in step S1004 and the subsequent steps.

After the electrophoresis is performed again in step S1014, the processing unit 10 performs the processing in step S1001 and the subsequent steps.

A process that is performed by the saturation determination unit 113 according to the third example of the third embodiment is the same as the process illustrated in FIG. 12, and illustration and description thereof are omitted. However, in the third example of the third embodiment, after the electrophoresis of the analysis target sample D10 is performed again, the process illustrated in FIG. 12 is performed.

In addition, the process that is performed by the saturation determination unit 113 is the same as the process illustrated in FIG. 12, and illustration and description thereof are omitted.

### [Operation]

In the third example of the third embodiment, as in the first example of the third embodiment, whether saturation has occurred is determined based on the sum of the squares of the differences between the normalized saturation reference sample signal and the fluorescent spectrum data D22 (S1007). Therefore, it is possible to add the saturation mark to a frame in which saturation has occurred, regardless of a difference between saturation electrical charge amounts of devices. The other operation is the same as that in the third example of the first embodiment.

### [Effects]

In the third example of the third embodiment, in addition to the effects obtained in the first example of the third embodiment, the saturation determination value D30 can be approximately determined by electrophoresing the saturation reference sample D40 once. The reason why such an effect is obtained is the same as that in the third example of the first embodiment.

In the third embodiment, the spectra SP of the analysis target sample signal D11 and the saturation reference sample signal D41 are compared with the fluorescent spectrum data D22 having the predetermined shape. The saturation determination value setting unit 112 and the saturation determination unit 113 determine that saturation has occurred in the measurement unit 20 in a case where the shape of each of the spectra SP deviates from the fluorescent spectrum data D22 (the sum of the squares is greater than or equal to the third threshold).

In the present example of the third embodiment, the saturation determination value setting unit 112 and the Saturation determination unit 113 determine whether Saturation has occurred in the measurement unit 20, based on the shape of a spectrum generated using the following methods.

(A1) In the first embodiment, whether saturation has occurred is determined based on whether the spectrum SP of the analysis target sample signal D11 and the saturation reference sample signal D41 significantly deviate from the Gaussian distribution.

(Z2) In the second embodiment, it is determined whether the absolute value DIF of the second derivative of the spectrum SP of each of the analysis target sample signal D11 and the saturation reference sample signal D41 is greater than or equal to the second threshold TH2. By performing this, whether saturation has occurred is determined.

(Z3) In the third embodiment, the sum of the squares of the differences between each of the normalized analysis target sample signal D11 and the saturation reference sample signal D41 and the fluorescent spectrum data D22 is calculated. Then, whether saturation has occurred is determined by determining whether the sum of the squares of the differences is greater than or equal to the third threshold.

### Hardware Configuration

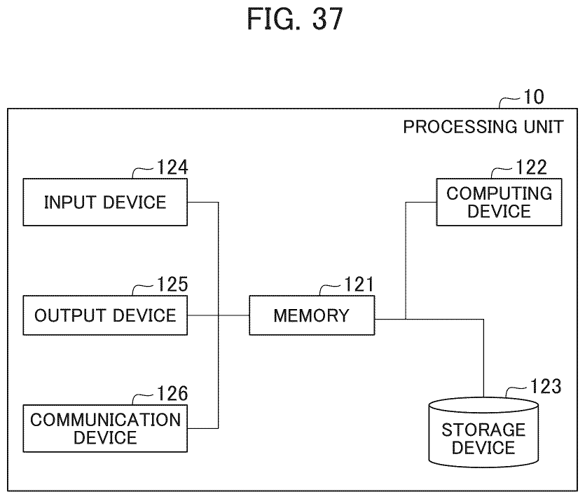

FIG. 37 is a diagram illustrating a hardware configuration of each of the processing units 10.

The processing unit 10 includes a computing device 122 having a memory 121, a central processing unit (CPU), a graphic processing unit (GPU), and the like. The processing unit 10 further includes a storage device 123 that is a hard disk (HD) or a solid-state drive (SSD). The processing unit 10 further includes an input device 124 such as a keyboard and a mouse, an output device 125 such as a display, and a communication device 126 that acquires information from the measurement unit 20.

A program stored in the storage device 123 is loaded into the memory 121. The loaded program is executed by the computing device 122. This implements the fluorescence calibration unit 101, the pseudo inverse matrix generation unit 102, the color conversion unit 103, the spectrum generation unit 111, the saturation determination value setting unit 112, and the saturation determination unit 113.

In the first embodiment, the Gaussian distribution and the spectrum SP of the analysis target sample signal D11 are compared with each other. However, a shape close to the spectrum SP of the analysis target sample signal D11 in which saturation has not occurred may be used instead of the Gaussian distribution. For example, a spectrum SP of the analysis target sample signal D11 in which it is known that saturation has not occurred may be used instead of the Gaussian distribution. Alternatively, an averaged spectrum SP of the analysis target sample signal D11 in which it is known that much saturation have not occurred may be used instead of the Gaussian distribution.

The present invention is not limited to the embodiments and includes various modifications. For example, the embodiments are described above in detail in order to clearly explain the present invention and are not necessarily limited to having all of the configurations described above. In addition, it is possible to replace a part of the configuration of a certain embodiment with the configuration of another embodiment, and it is also possible to add the configuration of another embodiment to the configuration of a certain embodiment. In addition, it is possible to add, remove, or replace a part of the configuration of each of the embodiments to, from, or with another configuration.

In addition, some or all of the above-described configurations, the above-described functions, the units 101 to 103 and 111 to 113, the storage device 123, and the like may be implemented in hardware by, for example, designing with an integrated circuit. In addition, as illustrated in FIG. 37, the above-described configurations, the above-described functions, and the like may be implemented in software by a processor, such as a CPU, interpreting and executing a program for implementing each of the functions. Information such as the program, a table, a file, and the like for implementing each of the functions can be stored in a storage device such as a memory, and an SSD, or a storage media such as an integrated circuit (IC) card, a secure digital (SD) card, and a digital versatile disc (DVD).

In each of the embodiments, the control lines and the information lines are those that are considered necessary for the explanation, and not all the control lines and information lines in the product are necessarily illustrated. In fact, almost all configurations are considered to be connected to each other.

### LIST OF REFERENCE SIGNS

1: Electrophoresis device
10: Processing unit (electrophoresis data processing device)
20: Measurement unit
111: Spectrum generation unit
112: Saturation determination value setting unit (saturation determination processing unit)
113: Saturation determination unit (saturation determination processing unit)
210: CCD image sensor
211: Light receiving unit
211A: Light receiving element
212: Accumulation unit
213: Electrical charge storage unit
213A: Electrical charge storage element
214: Horizontal register unit
214A: Horizontal register
215: Summing gate
220: Control unit
240: Capillary array
241: Capillary
D10: Analysis target sample
D11: Analysis target sample signal
D20: Matrix standard
D21: Matrix standard signal
D22: Fluorescent spectrum data
D23: Pseudo inverse matrix
D24: Fluorescent signal data
D30: Saturation determination value
D40: Saturation reference sample
D41: Saturation reference sample signal
DIF: Absolute value of second derivative
TH1: First threshold
TH2: Second threshold
SP, SP1 to SP4: Spectrum
SR1 to SR3: Reference sign
S101, S301, S501, S601, S801, S901: Acquisition of analysis target sample signal (signal acquisition step)
S102, S302, S402, S502, S602, S702, S803, S903, S1003: Drawing of spectrum for each frame (spectrum generation step)
S104, S304, S404: Determination as to whether shape significantly deviates from Gaussian distribution (saturation determination step)
S401, S701, S1001: Acquisition of saturation reference sample signal (signal acquisition step)
S505, S605, S705: Determination as to whether maximum absolute value of second derivative is greater than or equal to second threshold (saturation determination step)
S807, S907, S1007: Determination as to whether sum of squares of differences is greater than or equal to third threshold (saturation determination step)

1. An electrophoresis data processing device comprising:
a spectrum generation unit that generates a spectrum of a signal acquired from a measurement unit of an electrophoresis device in which binning is performed to virtually integrate light receiving elements that receive light dispersed from fluorescence emitted from a capillary included in the electrophoresis device; and
a saturation determination processing unit that determines, based on a shape of the generated spectrum, whether saturation has occurred in the measurement unit.

2. The electrophoresis data processing device according to claim 1, wherein
the saturation determination processing unit compares the shape of the spectrum with a predetermined shape, and determines that the saturation has occurred in the measurement unit in a case where the shape of the spectrum deviates from the predetermined shape.

3. The electrophoresis data processing device according to claim 2, wherein
the predetermined shape is a shape of a Gaussian distribution.

4. The electrophoresis data processing device according to claim 2, wherein
the predetermined shape is a shape of fluorescent spectrum data, and
the saturation determination processing unit compares the shape of the fluorescent spectrum data with a spectrum having a normalized signal intensity obtained by normalizing a signal intensity that is an intensity of the signal.

5. The electrophoresis data processing device according to claim 1, wherein
in a case where a value obtained as a result of second-order differentiation of the shape of the spectrum exceeds a predetermined threshold, the saturation determination processing unit determines that the saturation has occurred in the signal acquired from the measurement unit.

6. The electrophoresis data processing device according to to claim 2, wherein
the saturation determination processing unit includes
a saturation determination value setting unit that sets, in the spectrum, as a saturation determination value, a lowest signal intensity among portions having signal intensities that are intensities of the signal and are substantially constant in a case where the saturation determination processing unit determines that the saturation, has occurred in the measurement unit, and
a saturation determination unit that adds, to the acquired signal, a mark indicating that the saturation has occurred in the signal when the signal intensity of the signal acquired from the measurement unit exceeds the saturation determination value.

7. The electrophoresis data processing device according to claim 1, wherein
the saturation determination processing unit adds, based on the shape of the spectrum, to the acquired signal, a mark indicating that the saturation has occurred in the signal acquired from the measurement unit in a case where the saturation determination processing unit determines that the saturation has occurred in the measurement unit.

8. The electrophoresis data processing device according to claim 1, wherein
the spectrum is generated based on a signal intensity obtained as a result of measuring a sample to be analyzed.

9. The electrophoresis data processing device according to claim 2, wherein
the spectrum is generated based on a signal intensity obtained as a result of measuring a saturation reference sample by the measurement unit.

10. An electrophoresis data processing method comprising:
a signal acquisition step of acquiring a signal from a measurement unit by an electrophoresis data processing device that processes the signal acquired from the measurement unit of an electrophoresis device in which binning is performed to virtually integrate light receiving elements that receive light dispersed from fluorescence emitted from a capillary included in the electrophoresis device;
a spectrum generation step of generating a spectrum of the acquired signal; and
a saturation determination step of determining, based on a shape of the generated spectrum, whether saturation has occurred in the measurement unit.
